(19) United States
(12) Patent Application Publication
(10) Pub. No.: US 2015/0346582 A1
(43) Pub. Date: Dec. 3, 2015

(54) OMNIDIRECTIONAL IMAGING DEVICE

(71) Applicant: Teknologian tutkimuskeskus VTT Oy, Espoo (FI)

(72) Inventors: Mika Aikio, VTT (FI); Jukka-Tapani Makinen, VTT (FI)

(21) Appl. No.: 14/725,048

(22) Filed: May 29, 2015

(30) Foreign Application Priority Data
May 30, 2014 (FI) 20145498

(51) Int. Cl. G03B 3/04; H04N 5/232

(52) U.S. Cl. CPC G03B 3/04; H04N 5/23238

(57) ABSTRACT

A panoramic camera includes an input element, an aperture stop, and a focusing unit, where the input element and the focusing unit are arranged to form an annular optical image on an image plane, and the aperture stop defines an entrance pupil of the imaging device such that the effective F-number of the imaging device is in the range of 1.0 to 5.6.

### FIELD

The present invention relates to optical imaging.

### BACKGROUND

A panoramic camera may comprise a fish-eye lens system for providing a panoramic image. The panoramic image may be formed by focusing an optical image on an image sensor. The fish-eye lens may be arranged to shrink the peripheral regions of the optical image so that the whole optical image can be captured by a single image sensor. Consequently, the resolving power of the fish-eye lens may be limited at the peripheral regions of the optical image.

### SUMMARY

An object of the present invention is to provide a device for optical imaging. An object of the present invention is to provide a method for capturing an image.

According to a first aspect, there is provided an imaging device comprising:
an input element,
an aperture stop, and
a focusing unit,

wherein the input element and the focusing unit are arranged to form an annular optical image on an image plane, and the aperture stop defines an entrance pupil of the imaging device such that the effective F-number of the imaging device is in the range of 1.0 to 5.6.

According to a second aspect, there is provided a method for capturing an image by using an imaging device, the imaging device comprising an input element, an aperture stop, and a focusing unit, the method comprising forming an annular optical image on an image plane, wherein the aperture stop defines an entrance pupil of the imaging device such that the effective F-number of the imaging device is in the range of 1.0 to 5.6.

The aperture stop may provide high light collection power, and the aperture stop may improve the sharpness of the image by preventing propagation of marginal rays, which could cause blurring of the optical image. In particular, the aperture stop may prevent propagation of those marginal rays which could cause blurring in the tangential direction of the annular optical image.

The imaging device may form an annular optical image, which represents the surroundings of the imaging device. The annular image may be converted into a rectangular panorama image by digital image processing.

The radial distortion of the annular image may be low. In other words, the relationship between the elevation angle of rays received from the objects and the positions of the corresponding image points may be substantially linear. Consequently, the pixels of the image sensor may be used effectively for a predetermined vertical field of view, and all parts of the panorama image may be formed with an optimum resolution.

The imaging device may have a substantially cylindrical object surface. The imaging device may effectively utilize the pixels of the image sensor for capturing an annular image, which represents the cylindrical object surface. For certain applications, it is not necessary to capture images of objects, which are located directly above the imaging device. For those applications, the imaging device may utilize the pixels of an image sensor more effectively when compared with e.g. a fish-eye lens. The imaging device may be attached e.g. to a vehicle in order to monitor obstacles, other vehicles and/or persons around the vehicle. The imaging device may be used e.g. as a stationary surveillance camera. The imaging device may be arranged to capture images for a machine vision system.

In an embodiment, the imaging device may be arranged to provide panorama images for a teleconference system. For example, the imaging device may be arranged to provide a panorama image of several persons located in a single room. A teleconference system may comprise one or more imaging devices for providing and transmitting panorama images. The teleconference system may capture and transmit a video sequence, wherein the video sequence may comprise one or more panorama images.

The imaging device may comprise an input element, which has two refractive surfaces and two reflective surfaces to provide a folded optical path. The folded optical path may allow reducing the size of the imaging device. The imaging device may have a low height, due to the folded optical path.

### BRIEF DESCRIPTION OF THE DRAWINGS

FIG. 1 shows, by way of example, in a cross sectional view, an imaging device which comprises an omnidirectional lens,

FIG. 2 shows, by way of example, in a cross sectional view, an imaging device which comprises the omnidirectional lens,

FIG. 3a shows, by way of example, in a three dimensional view, forming an annular optical image on an image sensor,

FIG. 3b shows, by way of example, in a three dimensional view, forming several optical images on the image sensor,

FIG. 4 shows, by way of example, in a three dimensional view, upper and lower boundaries of the viewing region of the imaging device,

FIG. 5a shows an optical image formed on the image sensor,

FIG. 5b shows by way of example, forming a panoramic image from the captured digital image,

FIG. 6a shows, by way of example, in a three-dimensional view, an elevation angle corresponding a point of an object,

FIG. 6b shows, by way of example, in a top view, an image point corresponding to the object point of FIG. 6a

FIG. 7a shows, by way of example, in a side view, an entrance pupil of the imaging device,

FIG. 7b shows, by way of example, in an end view, the entrance pupil of FIG. 7a,

FIG. 7c shows, by way of example, in a top view, the entrance pupil of FIG. 7a,

FIG. 8a shows, by way of example, in a top view, the aperture stop of the imaging device,

FIG. 8b shows, by way of example, in an end view, rays passing through the aperture stop,

FIG. 8c shows, by way of example, in a side view, rays passing through the aperture stop,

FIG. 8d shows, by way of example, in an end view, propagation of peripheral rays in the imaging device,

FIG. 8e shows, by way of example, in a top view, propagation of peripheral rays from the input surface to the aperture stop,

FIG. 9a shows, by way of example, in a side view, rays impinging on the image sensor,

FIG. 9b shows, by way of example, in an end view, rays impinging on the image sensor,

FIG. 9c shows modulation transfer functions for several different elevation angles,

FIG. 10 shows by way of example, functional units of the imaging device,

FIG. 11 shows, by way of example, characteristic dimensions of the input element,

FIG. 12 shows by way of example, an imaging device implemented without the beam modifying unit, and

FIG. 13 shows by way of example, detector pixels of an image sensor.

### DETAILED DESCRIPTION

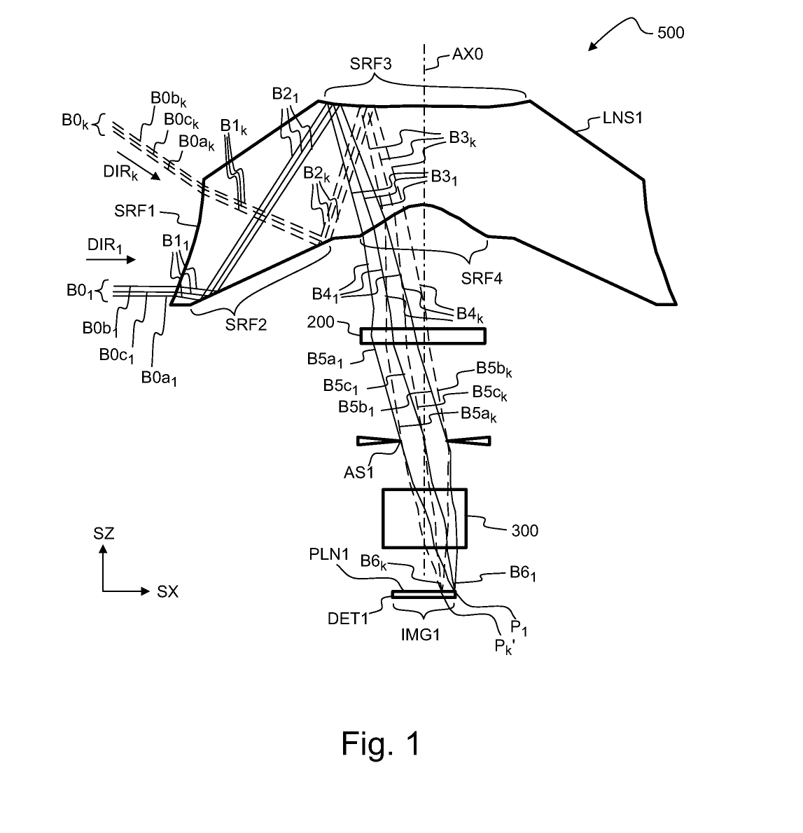

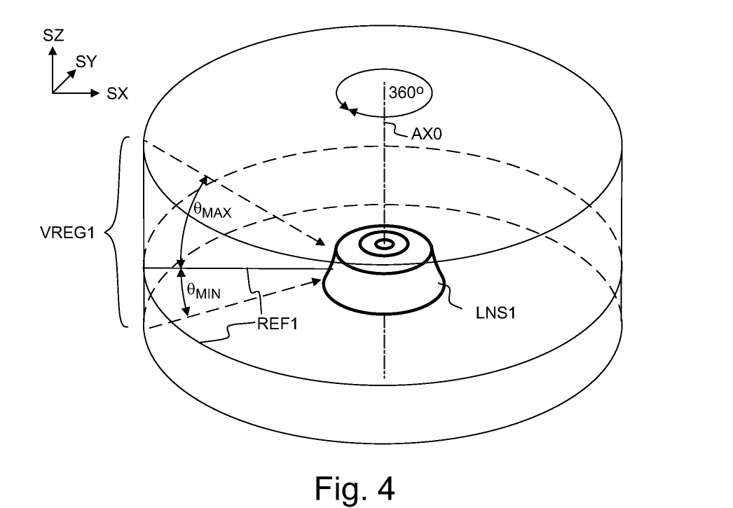

Referring to FIG. 1, an imaging device 500 may comprise an input element LNS1, an aperture stop AS1, a focusing unit 300, and an image sensor DET1. The imaging device 500 may have a wide viewing region VREG1 about an axis AX0 (FIG. 4). The imaging device 500 may have a viewing region VREG1, which completely surrounds the optical axis AX0. The viewing region VREG1 may represent 360° angle about the viewing region VREG1. The input element LNS1 may be called e.g. as an omnidirectional lens or as a panoramic lens. The optical elements of the imaging device 500 may form a combination, which may be called e.g. as the omnidirectional objective. The imaging device 500 may be called e.g. as an omnidirectional imaging device or as a panoramic imaging device. The imaging device 500 may be e.g. a camera.

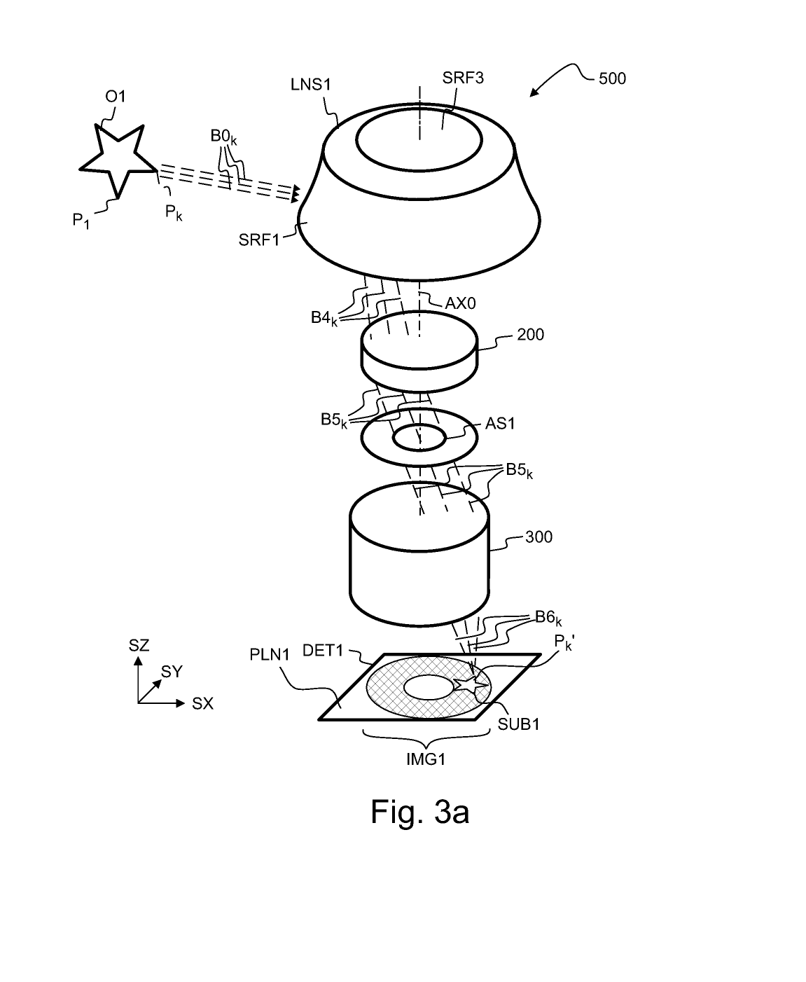

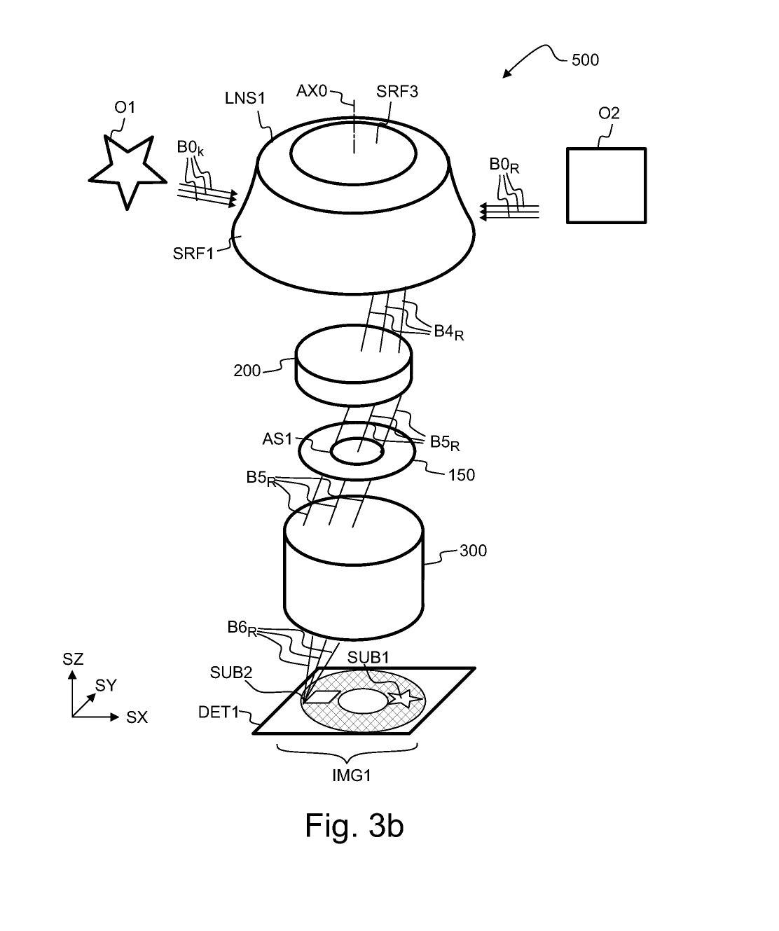

The optical elements of the device 500 may be arranged to refract and/or reflect light of one or more light beams. Each beam may comprise a plurality light rays. The input element LNS1 may comprise an input surface SRF1, a first reflective surface SRF2, a second reflective surface SRF3, and an output surface SRF4. A first input beam B0₁ may impinge on the input surface SRF1. The first input beam B0₁ may be received e.g. from a point P₁ of an object O1 (FIG. 3a). The input surface SRF1 may be arranged to provide first refracted light B1₁ by refracting light of the input beam B0₁, the first reflective surface SRF2 may be arranged to provide a first reflected beam B2₁ by reflecting light of the first refracted beam B1₁, the second reflective surface SRF3 may be arranged to provide second reflected beam B3₁ by reflecting light of the first reflected beam B2₁, and the output surface SRF4 may be arranged to provide an output beam B4₁ by refracting light of the second reflected beam B3₁.

The input surface SRF1 may have a first radius of curvature in the vertical direction, and the input surface SRF1 may have a second radius of curvature in the horizontal direction. The second radius may be different from the first radius, and refraction at the input surface SRF1 may cause astigmatism. In particular, the input surface SRF1 may be a portion of a toroidal surface. The reflective surface SRF2 may be e.g. a substantially conical surface. The reflective surface SRF2 may cross-couple the tangential and sagittal optical power, which may cause astigmatism and coma (comatic aberration). The refractive surfaces SRF1 and SRF4 may contribute to the lateral color characteristics. The shapes of the surfaces SRF1, SRF2, SRF3, SRF4 may be optimized e.g. to minimize total amount of astigmatism, coma and/or chromatic aberration. The shapes of the surfaces SRF1, SRF2, SRF3, SRF4 may be iteratively optimized by using optical design software, e.g. by using a software available under the trade name “Zemax”. Examples of suitable shapes for the surfaces are specified e.g. in Tables 1.2 and 1.3, and in Tables 2.2, 2.3.

The imaging device 500 may optionally comprise a wavefront modifying unit 200 to modify the wavefront of output beams provided by the input element LNS1. The wavefront of the output beam B4₁ may be optionally modified by the wavefront modifying unit 200. The wavefront modifying unit 200 may be arranged to form an intermediate beam B5₁ by modifying the wavefront of the output beam B4₁. The intermediate beam may also be called e.g. as a corrected beam or as a modified beam.

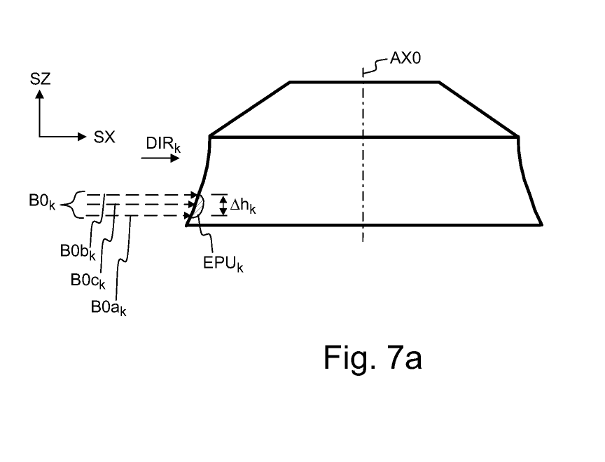

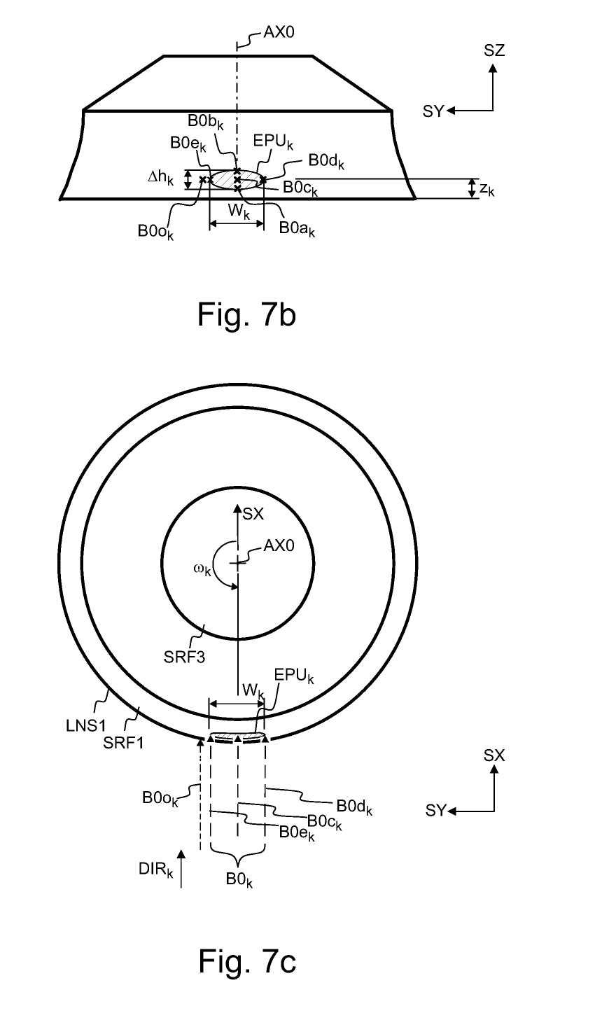

The aperture stop AS1 may be positioned between the input element LNS1 and the focusing unit 300. The aperture stop may be positioned between the modifying unit 200 and the focusing unit 300. The aperture stop AS1 may be arranged to limit the transverse dimensions of the intermediate beam B5₁. The aperture stop AS1 may also define the entrance pupil of the imaging device 500 (FIG. 7b).

The light of the intermediate beam B5₁ may be focused on the image sensor DET1 by the focusing unit 300. The focusing unit 300 may be arranged to form a focused beam B6₁ by focusing light of the intermediate beam B5₁. The focused beam B6₁ may impinge on a point P₁′ of the image sensor DET1. The point P₁′ may be called e.g. as an image point. The image point may overlap one or more detector pixels of the image sensor DET1, and the image sensor DET1 may provide a digital signal indicative of the brightness of the image point.

A second input beam B0ₖ may impinge on the input surface SRF1. The direction DIRₖ of the second input beam B0ₖ may be different from the direction DIR₁ of the first input beam B0₁. The beams B0₁, B0ₖ may be received e.g. from two different points P₁, Pₖ of an object O1.

The input surface SRF1 may be arranged to provide a refracted beam B1ₖ by refracting light of the second input beam B0ₖ, the first reflective surface SRF2 may be arranged to provide a reflected beam B2ₖ by reflecting light of the refracted beam B1ₖ, the second reflective surface SRF3 may be arranged to provide a reflected beam B3ₖ by reflecting light of the reflected beam B2ₖ, and the output surface SRF4 may be arranged to provide an output beam B4ₖ by refracting light of the reflected beam B3ₖ. The wavefront modifying unit 200 may be arranged to form an intermediate beam B5ₖ by modifying the wavefront of the output beam B4ₖ. The aperture stop AS1 may be arranged to limit the transverse dimensions of the intermediate beam B5ₖ. The focusing unit 300 may be arranged to form a focused beam B6ₖ by focusing light of the intermediate beam B5ₖ. The focused beam B6ₖ may impinge on a point Pₖ′ of the image sensor DET1. The point Pₖ′ may be spatially separate from the point P₁′.

The input element LNS1 and the focusing unit 300 may be arranged to form an optical image IMG1 on the image sensor DET1, by receiving several beams B0₁, B0ₖ from different directions DIR₁, DIRₖ.

The input element LNS1 may be substantially axially symmetric about the axis AX0. The optical components of the imaging device 500 may be substantially axially symmetric about the axis AX0. The input element LNS1 may be axially symmetric about the axis AX0. The axis AX0 may be called e.g. as the symmetry axis, or as the optical axis.

The input element LNS1 may also be arranged to operate such that the wavefront modifying unit 200 is not needed. In that case the surface SRF4 of the input element LNS1 may directly provide the intermediate beam B5₁ by refracting light of the reflected beam B5₁. The surface SRF4 of the input element LNS1 may directly provide the intermediate beam B5ₖ by refracting light of the reflected beam B5ₖ. In this case, the output beam of the input element LNS1 may be directly used as the intermediate beam B5ₖ.

The aperture stop AS1 may be positioned between the input element LNS1 and the focusing unit 300. The center of the aperture stop AS1 may substantially coincide with the axis AX0. The aperture stop AS1 may be substantially circular.

The input element LNS1, the optical elements of the (optional) modifying unit 200, the aperture stop AS1, and the optical elements of the focusing unit 300 may be substantially axially symmetric with respect to the axis AX0.

The input element LNS1 may be arranged to operate such that the second reflected beam B3ₖ formed by the second reflective surface SRF3 does not intersect the first refracted beam B1ₖ formed by the input surface SRF1.

The first refracted beam B1ₖ, the first reflected beam B2ₖ, and the second reflected beam B3ₖ may propagate in a substantially homogeneous material without propagating in a gas.

The imaging device 500 may be arranged to form the optical image IMG1 on an image plane PLN1. The active surface of the image sensor DET1 may substantially coincide with the image plane PLN1. The image sensor DET1 may be positioned such that the light-detecting pixels of the image sensor DET1 are substantially in the image plane PLN1. The imaging device 500 may be arranged to form the optical image IMG1 on the active surface of the image sensor DET1. The image plane PLN1 may be substantially perpendicular to the axis AX0.

The image sensor DET1 may be attached to the imaging device 500 during manufacturing the imaging device 500 so that the imaging device 500 may comprise the image sensor DET1. However, the imaging device 500 may also be provided without the image sensor DET1. For example, the imaging device 500 may be manufactured or transported without the image sensor DET1. The image sensor DET1 may be attached to the imaging device 500 at a later stage, prior to capturing the images IMG1.

SX, SY, and SZ denote orthogonal directions. The direction SY is shown e.g. in FIG. 3a. The symbol k may denote e.g. a one-dimensional or a two-dimensional index. For example, the imaging device 500 may be arranged to form an optical image IMG1 by focusing light of several input beams B0₁, B0₂, B0₃, . . . B0ₖ₋₁, B0ₖ, B0ₖ₊₁ . . . .

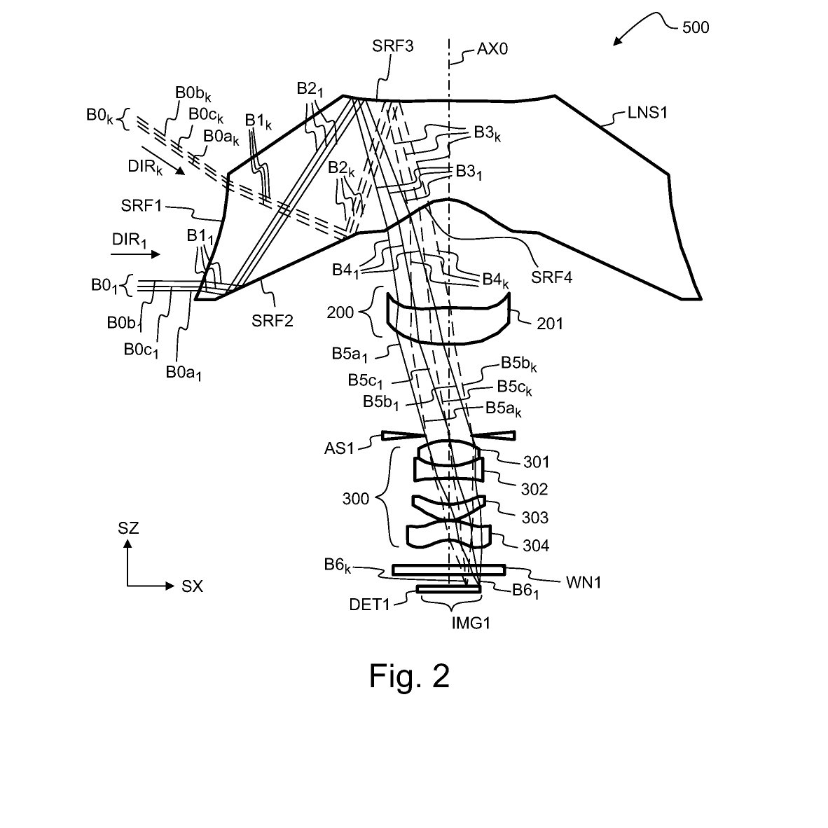

Referring to FIG. 2, the focusing unit 300 may comprise e.g. one or more lenses 301, 302, 303, 304. The focusing unit 300 may be optimized for off-axis performance.

The imaging device 500 may optionally comprise a window WN1 to protect the surface of the image sensor DET1.

The wavefront modifying unit 200 may comprise e.g. one or more lenses 201. The wavefront modifying unit 200 may be arranged to form an intermediate beam B5ₖ by modifying the wavefront of the output beam B4ₖ. In particular, the input element LNS1 and the wavefront modifying unit 200 may be arranged to form a substantially collimated intermediate beam B5ₖ from the light of a collimated input beam B0ₖ. The collimated intermediate beam B5ₖ may have a substantially planar waveform.

In an embodiment, the input element LNS1 and the wavefront modifying unit 200 may also be arranged to form a converging or diverging intermediate beam B5ₖ. The converging or diverging intermediate beam B5ₖ may have a substantially spherical waveform.

Referring to FIG. 3a, the imaging device 500 may be arranged to focus light B6ₖ on a point Pₖ′ on the image sensor DET1, by receiving light B0ₖ from an arbitrary point Pₖ of the object O1. The imaging device 500 may be arranged to form an image SUB1 of an object O1 on the image sensor DET1. The image SUB1 of the object O1 may be called e.g. as a sub-image. The optical image IMG1 formed on the image sensor DET1 may comprise the sub-image SUB1.

Referring to FIG. 3b, the imaging device 500 may be arranged to focus light B6_{R} on the image sensor DET1, by receiving light B0_{R} from a second object O2. The imaging device 500 may be arranged to form a sub-image SUB2 of the second object O2 on the image sensor DET1. The optical image IMG1 formed on the image sensor DET1 may comprise one or more sub-images SUB1, SUB2. The optical sub-images SUB1, SUB2 may be formed simultaneously on the image sensor DET1. The optical image IMG1 representing the 360° view around the axis AX0 may be formed simultaneously and instantaneously.

In an embodiment, the objects O1, O2 may be e.g. on substantially opposite sides of the input element LNS1. The input element LNS1 may be located between a first object O1 and a second object O2.

The input element LNS1 may provide output light B4_{R} by receiving light B0_{R} from the second object O2. The wavefront modifying unit 200 may be arranged to form an intermediate beam B5_{R} by modifying the wavefront of the output beam B4_{R}. The aperture stop AS1 may be arranged to limit the transverse dimensions of the intermediate beam B5_{R}. The focusing unit 300 may be arranged to form a focused beam B6_{R} by focusing light of the intermediate beam B5_{R}.

Referring to FIG. 4, the imaging device 500 may have a viewing region VREG1. The viewing region VREG1 may also be called e.g. as the viewing volume or as the viewing zone. The imaging device 500 may form a substantially sharp image of an object O1 which resides within the viewing region VREG1.

The viewing region VREG1 may completely surround the axis AX0. The upper boundary of the viewing region VREG1 may be a conical surface, which has an angle 90°-θ_{MAX} with respect to the direction SZ. The angle θ_{MAX} may be e.g. in the range of +30° to +60°. The lower boundary of the viewing region VREG1 may be a conical surface, which has an angle 90°-θ_{MIN} with respect to the direction SZ. The angle θ_{MIN} may be e.g. in the range of −30° to +20°. The angle θ_{MAX} may represent the maximum elevation angle on an input beam with respect to a reference plane REF1, which is perpendicular to the direction SZ. The reference plane REF1 may be defined by the directions SX, SY. The angle θ_{MIN} may represent the minimum elevation angle on an input beam with respect to a reference plane REF1.

The vertical field of view (θ_{MAX}-θ_{MIN}) of the imaging device 500 may be defined by a first angle value θ_{MIN} and by a second angle value θ_{MAX}, wherein the first angle value θ_{MIN} may be lower than or equal to e.g. 0°, and the second angle value θ_{MAX} may be higher than or equal to e.g. +35°.

The vertical field of view (θ_{MAX}-θ_{MIN}) of the imaging device 500 may be defined by a first angle value θ_{MIN} and by a second angle value θ_{MAX}, wherein the first angle value θ_{MIN} is lower than or equal to −30°, and the second angle value θ_{MAX} is higher than or equal to +45°.

The vertical field of view (=θ_{MAX}-θ_{MIN}) of the device 500 may be e.g. in the range of 5° to 60°.

The imaging device 500 may be capable of forming the optical image IMG1 e.g. with a spatial resolution, which is higher than e.g. 90 line pairs per mm.

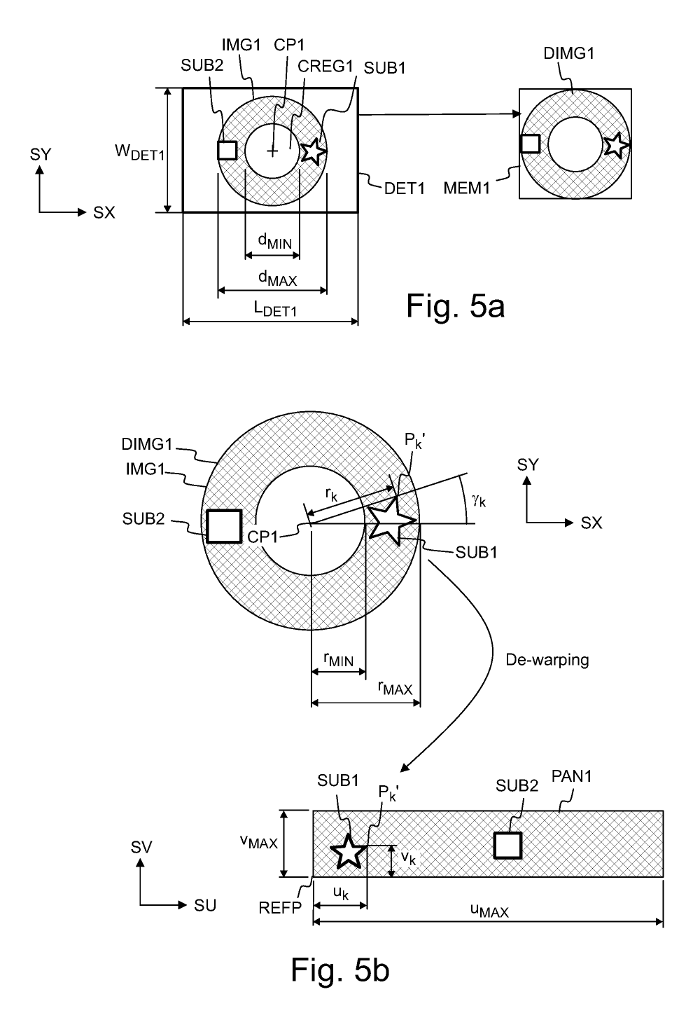

Referring to FIG. 5a, the imaging device 500 may form a substantially annular two-dimensional optical image IMG1 on the image sensor DET1. The imaging device 500 may form a substantially annular two-dimensional optical image IMG1 on an image plane PLN1, and the image sensor DET1 may be positioned in the image plane PLN1.

The image IMG1 may be an image of the viewing region VREG1. The image IMG1 may comprise one or more sub-images SUB1, SUB2 of objects residing in the viewing region VREG1. The optical image IMG1 may have an outer diameter d_{MAX} and an inner diameter d_{MIN}. The inner boundary of the optical image IMG1 may correspond to the upper boundary of the viewing region VREG1, and the outer boundary of the optical image IMG1 may correspond to the lower boundary of the viewing region VREG1. The outer diameter d_{MAX} may correspond to the minimum elevation angle θ_{MIN}, and the inner diameter d_{MIN} may correspond to the maximum elevation angle θ_{MAX}.

The image sensor DET1 may be arranged to convert the optical image IMG1 into a digital image DIMG1. The image sensor DET1 may provide the digital image DIMG1. The digital image DIMG1 may represent the annular optical image IMG1. The digital image DIMG1 may be called e.g. an annular digital image DIMG1.

The inner boundary of the image IMG1 may surround a central region CREG1 such that the diameter of the central region CREG1 is smaller than the inner diameter d_{MIN} of the annular image IMG1. The device 500 may be arranged to form the annular image IMG1 without forming an image on the central region CREG1 of the image sensor DET1. The image IMG1 may have a center point CP1. The device 500 may be arranged to form the annular image IMG1 without focusing light to the center point CP1.

The active area of the image sensor DET1 may have a length L_{DET1} and a width W_{DET1}. The active area means the area which is capable of detecting light. The width W_{DET1} may denote the shortest dimension of the active area in a direction which is perpendicular to the axis AX0, and the length L_{DET1} may denote the dimension of the active area in a direction, which is perpendicular to the width W_{DET1}. The width W_{DET1} of the sensor DET1 may be greater than or equal to the outer diameter d_{MAX} of the annular image IMG1 so that the whole annular image IMG1 may be captured by the sensor DET1.

Referring to FIG. 5b, the annular digital image DIMG1 may be converted into a panoramic image PAN1 by performing a de-warping operation. The panoramic image PAN1 may be formed from the annular digital image DIMG1 by digital image processing.

The digital image DIMG1 may be stored e.g. in a memory MEM1. However, the digital image DIMG1 may also be converted into the panoramic image PAN1 pixel by pixel, without a need to store the whole digital image DIMG1 in the memory MEM1.

The conversion may comprise determining signal values associated with the points of the panoramic image PAN1 from signal values associated with the points of the annular digital image DIMG1. The panorama image PAN1 may comprise e.g. a sub-image SUB1 of the first object O1 and a sub-image SUN2 of the second object O2. The panorama image PAN1 may comprise one or more sub-images of objects residing in the viewing region of the imaging device 500.

The whole optical image IMG1 may be formed instantaneously and simultaneously on the image sensor DET1. Consequently, the whole digital image DIMG1 may be formed without stitching, i.e. without combining two or more images taken in different directions. The panorama image PAN1 may be formed from the digital image DIMG1 without stitching.

In an embodiment, the imaging device 500 may remain stationary during capturing the digital image DIMG1, i.e. it is not necessary to change the orientation of the imaging device 500 for capturing the whole digital image DIMG1.

The image sensor DET1 may comprise a two-dimensional rectangular array of detector pixels, wherein the position of each pixel may be specified by coordinates (x,y) of a first rectangular system (Cartesian system). The image sensor DET1 may provide the digital image DIMG1 as a group of pixel values, wherein the position of each pixel may be specified by the coordinates. For example, the position of an image point Pₖ′ may be specified by coordinates xₖ,yₖ (or by indicating the corresponding column and the row of a detector pixel of the image sensor DET1).

In an embodiment, the positions of image points of the digital image DIMG1 may also be expressed by using polar coordinates (γₖ,rₖ). The positions of the pixels of the panorama image PAN1 may be specified by coordinates (u,v) of a second rectangular system defined by image directions SU and SV. The panorama image PAN1 may have a width u_{MAX}, and a height v_{MAX}. The position of an image point of the panorama image PAN1 may be specified by coordinates u,v with respect to a reference point REFP. An image point Pₖ′ of the annular image IMG1 may have coordinates polar coordinates (γₖ,rₖ), and the corresponding image point Pk′ of the panorama image PAN1 may have rectangular coordinates (uₖ, vₖ).

The de-warping operation may comprise mapping positions expressed in the polar coordinate system of the annular image DIMG1 into positions expressed in the rectangular coordinate system of the panorama image PAN1.

The imaging device 500 may provide a curvilinear i.e. distorted image IMG1 from its surroundings VREG1. The imaging device 500 may provide a large field size and sufficient resolving power, wherein the image distortion caused by the imaging device 500 may be corrected by digital image processing.

In an embodiment, the device 500 may also form a blurred optical image on the central region CREG1 of the image sensor DET1. The imaging device 500 may be arranged to operate such that the panorama image PAN1 is determined mainly from the image data obtained from the annular region defined by the inner diameter d_{MIN} and the outer diameter d_{MAX}.

The annular image IMG1 may have an inner radius r_{MIN} (=d_{MIN}/2) and an outer radius r_{MAX} (=d_{MAX}/2). The imaging device 500 may focus the light of the input beam B0ₖ to the detector DET1 such that the radial coordinate rₖ may depend on the elevation angle θₖ of the input beam B0ₖ.

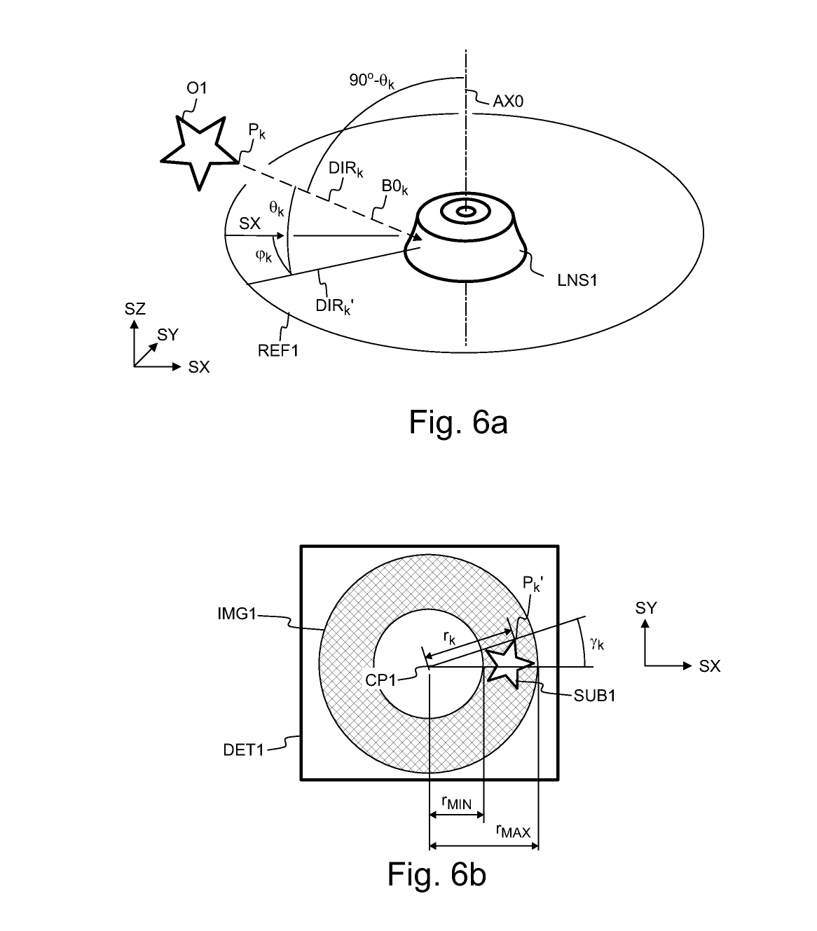

Referring to FIG. 6a, the input surface SRF1 of the device 500 may receive an input beam B0ₖ from an arbitrary point Pₖ of an object O1. The beam B0ₖ may propagate in a direction DIRₖ defined by an elevation angle θₖ and by an azimuth angle φₖ. The elevation angle θₖ may denote the angle between the direction DIRₖ of the beam B0ₖ and the horizontal reference plane REF1. The direction DIRₖ of the beam B0ₖ may have a projection DIRₖ′ on the horizontal reference plane REF1. The azimuth angle φₖ may denote the angle between the projection DIRₖ′ and a reference direction. The reference direction may be e.g. the direction SX.

The beam B0ₖ may be received e.g. from a point Pₖ of the object O1. Rays received from a remote point Pₖ to the entrance pupil EPUₖ of the input surface SRF1 may together form a substantially collimated beam B0ₖ. The input beam B0ₖ may be a substantially collimated beam.

The reference plane REF1 may be perpendicular to the symmetry axis AX0. The reference plane REF1 may be perpendicular to the direction SY. When the angles are expressed in degrees, the angle between the direction SZ and the direction DIR1 of the beam B0ₖ may be equal to 90°-θₖ. The angle 90°-θₖ may be called e.g. as the vertical input angle.

The input surface SRF1 may simultaneously receive several beams from different points of the object O1.

Referring to FIG. 6b, the imaging device 500 may focus the light of the beam B0ₖ to a point Pₖ′ on the image sensor DET1. The position of the image point Pₖ′ may be specified e.g. by polar coordinates γₖ, rₖ. The annular optical image IMG1 may have a center point CP1. The angular coordinate γₖ may specify the angular position of the image point Pₖ′ with respect to the center point CP1 and with respect to a reference direction (e.g. SX). The radial coordinate rₖ may specify the distance between the image point Pₖ′ and the center point CP1. The angular coordinate γₖ of the image point P_{k′} may be substantially equal to the azimuth angle φₖ of the input beam B0ₖ.

The annular image IMG1 may have an inner radius r_{MIN} and an outer radius r_{MAX}. The imaging device 500 may focus the light of the input beam B0ₖ to the detector DET1 such that the radial coordinate rₖ may depend on the elevation angle θₖ of said input beam B0ₖ.

The ratio of the inner radius r_{MIN} to the outer radius r_{MAX} may be e.g. in the range of 0.3 to 0.7.

The radial position rₖ may depend on the elevation angle θₖ in a substantially linear manner. An input beam B0ₖ may have an elevation angle θₖ, and the input beam B0ₖ may provide an image point Pₖ′ which has a radial position rₖ. An estimate r_{k,est} for the radial position rₖ may be determined from the elevation angle θₖ e.g. by the following mapping equation:

r_{k,est}=r_{MIN}+f₁(θₖ−θ_{MIN} (1)

f₁ may denote the focal length of the imaging device 500. The angles of equation (1) may be expressed in radians. The focal length f₁ of the imaging device 500 may be e.g. in the range of 0.5 to 20 mm.

The input element LNS1 and the optional modifying unit 200 may be arranged to operate such that the intermediate beam B5ₖ is substantially collimated. The input element LNS1 and the optional modifying unit 200 may be arranged to operate such that the intermediate beam B5ₖ has a substantially planar wavefront. The focal length f₁ of the imaging device 500 may be substantially equal to the focal length of the focusing unit 300 when the intermediate beam B5ₖ is substantially collimated after passing through the aperture stop AS1.

The input element LNS1 and the wavefront modifying unit 200 may be arranged to provide an intermediate beam B5ₖ such that the intermediate beam B5ₖ is substantially collimated after passing through the aperture stop AS1. The focusing unit 300 may be arranged to focus light of the intermediate beam B5ₖ to the image plane PLN1.

The input element LNS1 and the optional modifying unit 200 may also be arranged to operate such that the intermediate beam B5ₖ is not fully collimated after the aperture stop AS1. In that case the focal length f₁ of the imaging device 500 may also depend on the properties of the input element LNS1, and/or on the properties of the modifying unit 200 (if the device 500 comprises the unit 200).

In the general case, the focal length f₁ of the imaging device 500 may be defined based on the actual mapping properties of device 500, by using equation (2).

$${f}_{1} = \frac{{r}_{k + 1} - {r}_{k}}{{θ}_{k + 1} - {θ}_{k}} \qquad ( 2 )$$

The angles of equation (2) may be expressed in radians. θₖ denotes the elevation angle of a first input beam B0ₖ. θₖ₊₁ denotes the elevation angle of a second input beam B0ₖ₊₁. The angle θₖ₊₁ may be selected such that the difference θₖ₊₁-θₖ is e.g. in the range of 0.001 to 0.02 radians. The first input beam B0ₖ may form a first image point Pₖ′ on the image sensor DET1. rₖ denotes the radial position of the first image point Pₖ′. The second input beam B0ₖ₊₁ may form a second image point Pₖ₊₁′ on the image sensor DET1. rₖ denotes the radial position of the first image point Pₖ′.

θ_{MIN} may denote the elevation angle, which corresponds to the inner radius r_{MIN} of the annular image IMG1. The focal length f₁ of the imaging device 500 may be e.g. in the range of 0.5 to 20 mm. In particular, the focal length f₁ may be in the range of 0.5 mm to 5 mm.

The relationship between the elevation angle θₖ of the input beam B0ₖ and the radial position rₖ of the corresponding image point Pₖ′ may be approximated by the equation (1). The actual radial position rₖ of the image point Pₖ′ may slightly deviate from the estimated value r_{k,est} given by the equation (1). The relative deviation Δr/r_{k,est} may be calculated by the following equation:

$$\frac{Δ r}{{r}_{k , est}} = \frac{{r}_{k} - {r}_{k , est}}{{r}_{k , est}} \cdot 100 \% \qquad ( 3 a )$$

The radial distortion of the image IMG1 may be e.g. smaller than 20%. This may mean that the relative deviation Δr/r_{k,est} of the radial position rₖ of each image point Pₖ′ from a corresponding estimated radial position r_{k,est} is smaller than 20%, wherein said estimated value r_{k,est} is determined by the linear mapping equation (1).

The shapes of the surfaces SRF1, SRF2, SRF3, SRF4 may be selected such that the relative deviation Δr/r_{k,est} is in the range of −20% to 20%.

The radial distortion of the optical image IMG1 may be smaller than 20% when the vertical field of view (θ_{MAX}-θ_{MIN}) is defined by the angles θ_{MIN}=0° and θ_{MAX}=+35°.

The root mean square (RMS) value of the relative deviation Δr/r_{k,est} may depend on the focal length f₁ of the imaging device 500. The RMS value of the relative deviation Δr/r_{k,est} may be calculated e.g. by the following equation:

$$RMS = \sqrt{\frac{1}{{r}_{MA X} - {r}_{MI N}} {\int }_{{r}_{MI N}}^{{r}_{MA X}} {( \frac{r - {r}_{est}}{{r}_{est}} )}^{2} d r} \qquad ( 3 b )$$

where

rₑₛₜ=r_{MIN}+f₁(θ(r)−θ_{MIN}) (3c)

θ(r) denotes the elevation angle of an input beam, which produces an image point at a radial position r with respect to the center point CP1. The angles of equation (3c) may be expressed in radians. The focal length f₁ of the imaging device 500 may be determined from the equation (3b), by determining the focal length value f₁, which minimizes the RMS value of the relative deviation over the range from r_{MIN} to r_{MAX}. The focal length value that provides the minimum RMS relative deviation may be used as the focal length of the imaging device 500. The focal length of the imaging device 500 may be defined to be the focal length value f₁ that provides the minimum RMS relative deviation.

The radial distortion may be compensated when forming the panorama image PAN1 from the image IMG1. However, the pixels of the image sensor DET1 may be used in an optimum way when the radial distortion is small, in order to provide a sufficient resolution at all parts of the panorama image PAN1.

The imaging device 500 may receive a plurality of input beams from different points of the object O1, and the light of each input beam may be focused on different points of the image sensor DET1 to form the sub-image SUB1 of the object O1.

Referring to FIGS. 7a to 7c, the input beam B0ₖ may be coupled to the input element LNS1 via a portion EPUₖ of the input surface SRF1. The portion EPUₖ may be called as the entrance pupil EPUₖ. The input beam B0ₖ may comprise e.g. peripheral rays B0aₖ, B0bₖ, B0dₖ, B0eₖ and a central ray B0cₖ. The aperture stop AS1 may define the entrance pupil EPUₖ by preventing propagation of marginal rays.

The entrance pupil EPUₖ may have a width Wₖ and a height Δhₖ. The position of the entrance pupil EPUₖ may be specified e.g. by the vertical position zₖ of the center of the entrance pupil EPUₖ, and by the polar coordinate angle ωₖ of the center of the entrance pupil EPUₖ. The polar coordinate ωₖ may specify the position of the center of the entrance pupil EPUₖ with respect to the axis AX0, by using the direction SX as the reference direction. The angle ωₖ may be substantially equal to the angle γₖ+180°.

The input beam B0ₖ may be substantially collimated, and the rays B0aₖ, B0bₖ, B0cₖ, B0dₖ, B0eₖ may be substantially parallel to the direction DIRₖ of the input beam B0ₖ. The aperture stop AS1 may define the position and the dimensions Wₖ, Δhₖ of the entrance pupil EPUₖ according to the direction DIRₖ of the input beam B0ₖ such that the position and the dimensions Wₖ, Δhₖ of the entrance pupil EPUₖ may depend on the direction DIRₖ of the input beam B0ₖ. The dimensions Wₖ, Δhₖ of the entrance pupil EPUₖ may depend on the direction DIRₖ of the input beam B0ₖ. The position of the center of the entrance pupil EPUₖ may depend on the direction DIRₖ of the input beam B0ₖ. The entrance pupil EPUₖ may be called as the entrance pupil of the imaging device 500 for rays propagating in the direction DIRₖ. The device 500 may simultaneously have several different entrance pupils for substantially collimated input beams received from different directions.

The imaging device 500 may be arranged to focus light of the input beam B0ₖ via the aperture stop AS1 to an image point Pₖ′ on the image sensor DET1. The aperture stop AS1 may be arranged to prevent propagation of rays, which would cause blurring of the optical image IMG1. The aperture stop AS1 may be arranged to define the dimensions Wₖ, Δhₖ of the entrance pupil EPUₖ. Furthermore, the aperture stop AS1 may be arranged to define the position of the entrance pupil EPUₖ.

For example, a ray LB0oₖ propagating in the direction DIRₖ may impinge on the input surface SRF1 outside the entrance pupil EPUₖ. The aperture stop AS1 may define the entrance pupil EPUₖ so that light of a ray LB0oₖ does not contribute to forming the image point Pₖ′. The aperture stop AS1 may define the entrance pupil EPUₖ so that the light of marginal rays does not propagate to the image sensor DET1, wherein said marginal rays propagate in the direction DIRₖ and impinge on the input surface SRF1 outside the entrance pupil EPUₖ.

Rays B0aₖ, B0bₖ, B0cₖ, B0dₖ, B0eₖ which propagate in the direction DIRₖ and which impinge on the entrance pupil EPUₖ may contribute to forming the image point Pₖ′. Rays which propagate in a direction different from the direction DIRₖ may contribute to forming another image point, which is different from the image point Pₖ′. Rays which propagate in a direction different from the direction DIRₖ do not contribute to forming said image point Pₖ′.

Different image points Pₖ′ may correspond to different entrance pupils EPUₖ. A first image point may be formed from first light received via a first entrance pupil, and a second image point may be formed from second light received via a second different entrance pupil. The imaging device 500 may form a first intermediate beam from the first light, and the imaging device 500 may form a second intermediate beam from the second light such that the first intermediate beam and the second intermediate beam pass through the common aperture stop AS1.

The input element LNS1 and the focusing unit 300 may be arranged to form an annular optical image IMG1 on the image sensor DET1 such that the aperture stop AS1 defines an entrance pupil EPUₖ of the imaging device 500, the ratio f₁/Wₖ of the focal length f₁ of the focusing unit 300 to the width Wₖ of the entrance pupil EPUₖ is in the range of 1.0 to 5.6, and the ratio f₁/Δhₖ of the focal length f₁ to the height Δhₖ of said entrance pupil EPUₖ is in the range of 1.0 to 5.6.

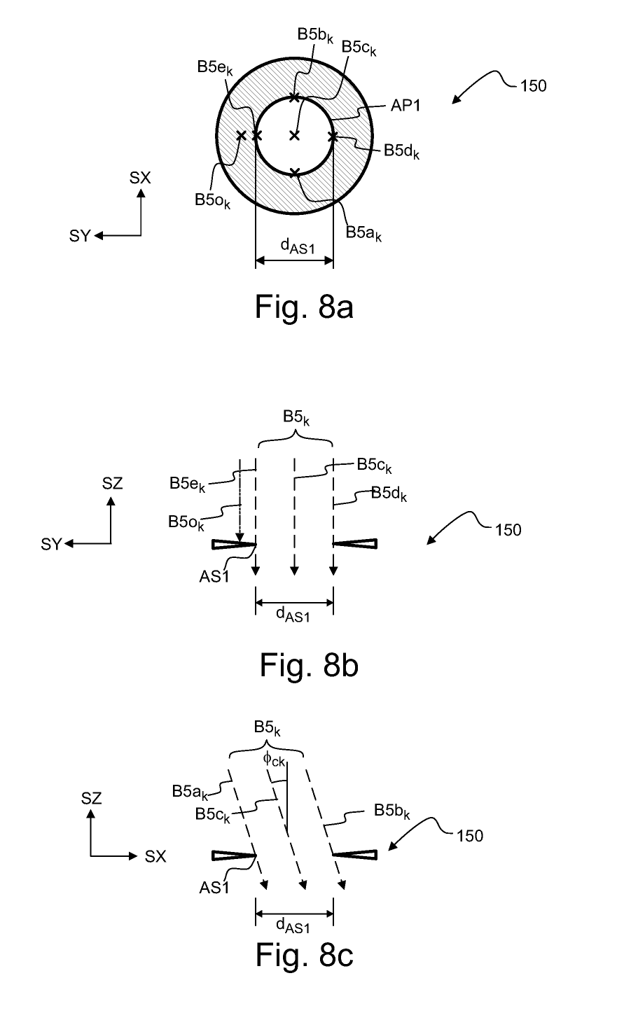

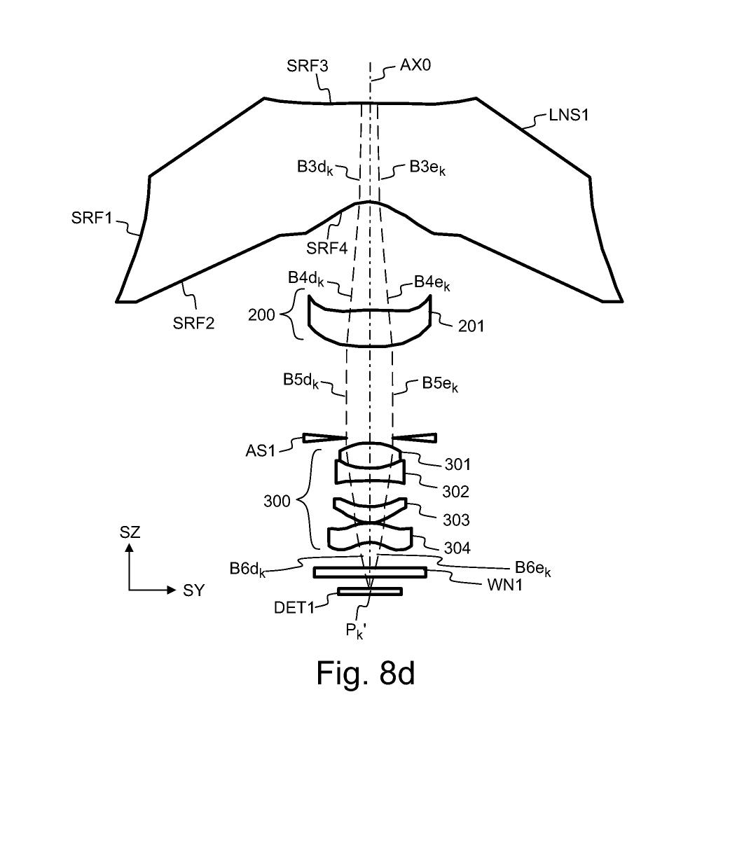

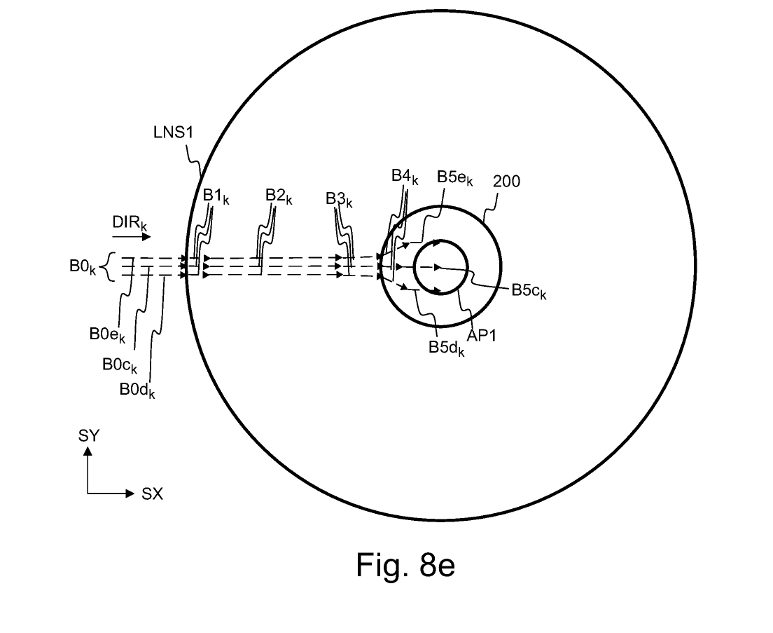

Referring to FIGS. 8a to 8c, the aperture stop AS1 may define the dimensions and the position of the entrance pupil EPUₖ by preventing propagation of marginal rays. The aperture stop AS1 may be substantially circular. The aperture stop AS1 may be defined e.g. by a hole, which has a diameter d_{AS1}. For example, an element 150 may have a hole, which defines the aperture stop AS1. The element 150 may comprise e.g. a metallic, ceramic or plastic disk, which has a hole. The diameter d_{AS1} of the substantially circular aperture stop AS1 may be fixed or adjustable. The element 150 may comprise a plurality of movable lamellae for defining a substantially circular aperture stop AS1, which has an adjustable diameter d_{AS1}.

The input beam B0ₖ may comprise rays B0aₖ, B0bₖ, B0cₖ, B0dₖ, B0eₖ which propagate in the direction DIRₖ.

The device 500 may form a peripheral ray B5aₖ by refracting and reflecting light of the ray B0aₖ. A peripheral ray B5bₖ may be formed from the ray B0bₖ. A peripheral ray B5dₖ may be formed from the ray B0dₖ. A peripheral ray B5eₖ may be formed from the ray B0eₖ. A central ray B5cₖ may be formed from the ray B0cₖ.

The horizontal distance between the rays B0aₖ, B0bₖ may be equal to the width Wₖ of the entrance pupil EPUₖ. The vertical distance between the rays B0dₖ, B0eₖ may be equal to the height Δhₖ of the entrance pupil EPUₖ.

A marginal ray B0oₖ may propagate in the direction DIRₖ so that the marginal ray B0oₖ does not impinge on the entrance pupil EPUₖ. The aperture stop AS1 may be arranged to block the marginal ray B0oₖ such that the light of said marginal ray B0oₖ does not contribute to forming the optical image IMG1. The device 500 may form a marginal ray B5oₖ, by refracting and reflecting light of the marginal ray B0oₖ. The aperture stop AS1 may be arranged to prevent propagation of the ray B5oₖ so that light of the ray B5oₖ does not contribute to forming the image point Pₖ′. The aperture stop AS1 may be arranged to prevent propagation of the light of the ray B0oₖ so that said light does not contribute to forming the image point Pₖ′.

A portion of the beam B5ₖ may propagate through the aperture stop AS1. Said portion may be called e.g. as the trimmed beam B5ₖ. The aperture stop AS1 may be arranged to form a trimmed beam B5ₖ by prevent propagation of the marginal rays B5oₖ. The aperture stop AS1 may be arranged to define the entrance pupil EPUₖ by preventing propagation of marginal rays B5oₖ.

The imaging device 500 may be arranged to form an intermediate beam B5ₖ by refracting and reflecting light of the input beam B0ₖ. The intermediate beam B5ₖ may comprise the rays B0aₖ, B0bₖ, B0cₖ, B0dₖ, B0eₖ. The direction of the central ray B5cₖ may be defined e.g. by an angle φ_{ck}. The direction of the central ray B5cₖ may depend on the elevation angle θₖ of the input beam B0ₖ.

FIG. 8d shows propagation of peripheral rays in the imaging device 500, when viewed from a direction which is parallel to the projected direction DIRₖ′ of the input beam B0ₖ. (the projected direction DIRₖ′ may be e.g. parallel with the direction SX). FIG. 8d shows propagation of peripheral rays from the surface SRF3 to the image sensor DET1. The surface SRF3 may form peripheral rays B3dₖ, B3eₖ by reflecting light of the beam B2ₖ. The surface SRF4 may form peripheral rays B4dₖ, B4eₖ by refracting light of the rays B3dₖ, B3eₖ. The modifying unit 200 may form peripheral rays B5dₖ, B5eₖ from the light of the rays B3dₖ, B3eₖ. The focusing unit 300 may form focused rays B6dₖ, B6eₖ by focusing light of the rays B5dₖ, B5eₖ.

FIG. 8e shows propagation of rays in the imaging device 500, when viewed from the top. FIG. 8e shows propagation of light from the input surface SRF1 to the aperture stop AP1. The input surface SRF1 may form a refracted beam B1ₖ by refracting light of the input rays B0cₖ, B0dₖ, B0eₖ. The surface SRF2 may form a reflected beam B2ₖ by reflecting light of the refracted beam B1ₖ. The surface SRF3 may form a reflected beam B3ₖ by reflecting light of the reflected beam B2ₖ. The surface SRF4 may form a refracted beam B4ₖ by refracting light of the reflected beam B3ₖ. The modifying unit 200 may form an intermediate beam B5ₖ from the refracted beam B4ₖ. The beam B5ₖ may pass via the aperture stop AP1 in order to prevent propagation of marginal rays.

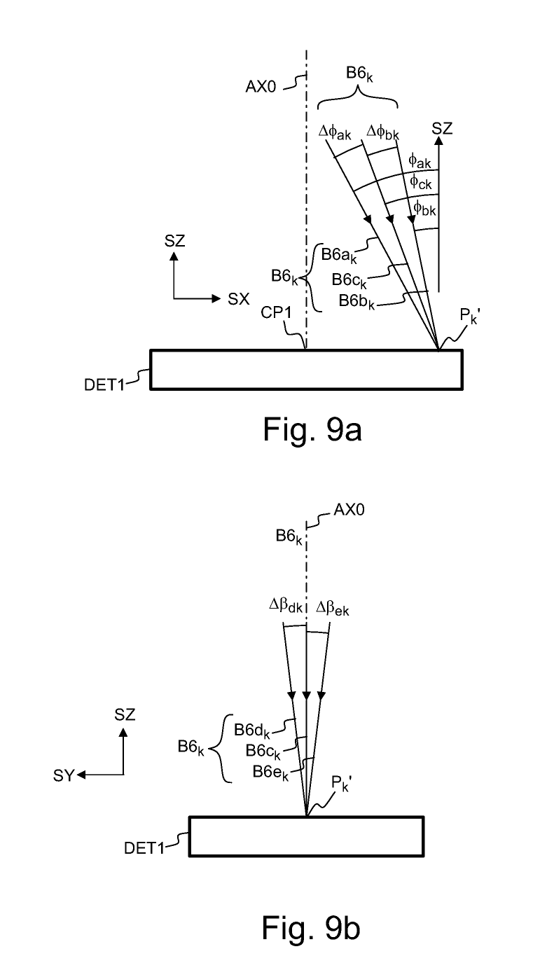

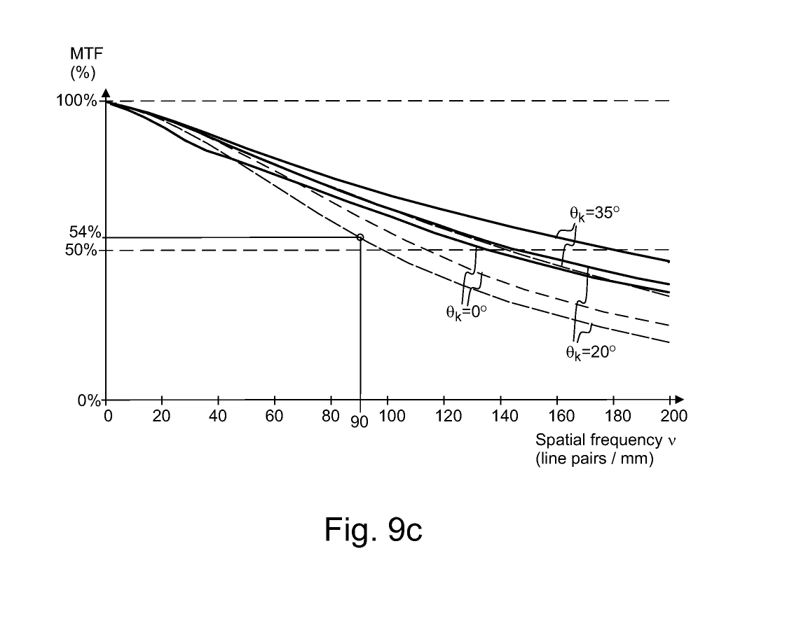

FIG. 9a shows rays impinging on the image sensor DET1 in order to form an image point Pₖ′. The focusing unit 300 may be arranged to form the image point Pₖ′ by focusing light of the intermediate beam B5ₖ. The intermediate beam B5ₖ may comprise e.g. peripheral rays B5aₖ, B5bₖ, B5dₖ, B5eₖ and a central ray B5cₖ. The focusing unit 300 may be arranged to provide a focused beam B6ₖ by focusing light of the intermediate beam B5ₖ. The focused beam B6ₖ may comprise e.g. rays B6aₖ, B6bₖ, B6cₖ, B6dₖ, B6eₖ. The focusing unit 300 may form a peripheral ray B6aₖ by refracting and reflecting light of the ray B5aₖ. A peripheral ray B6bₖ may be formed from the ray B5bₖ. A peripheral ray B6dₖ may be formed from the ray B5dₖ. A peripheral ray B6eₖ may be formed from the ray B6eₖ. A central ray B6cₖ may be formed from the ray B6cₖ.

The direction of the peripheral ray B6aₖ may be defined by an angle θₐₖ with respect to the axis AX0. The direction of the peripheral ray B6bₖ may be defined by an angle φ_{bk} with respect to the axis AX0. The direction of the central ray B6cₖ may be defined by an angle φ_{ck} with respect to the axis AX0. The rays B6aₖ, B6bₖ, B6cₖ may be in a first vertical plane, which includes the axis AX0. The first vertical plane may also include the direction DIRₖ of the input beam B0ₖ.

Δφₐₖ may denote the angle between the direction of the ray B6aₖ and the direction of the central ray B6cₖ. Δφ_{bk} may denote the angle between the direction of the ray B6bₖ and the direction of the central ray B6cₖ. The sum Δφₐₖ+Δφ_{bk} may denote the angle between the peripheral rays B6aₖ, B6bₖ. The sum Δφₐₖ+Δφ_{bk} may be equal to the cone angle of the focused beam B6ₖ in the radial direction of the annular optical image IMG1.

The direction of the peripheral ray B6dₖ may be defined by an angle Δβ_{dk} with respect to the direction of the central ray B6cₖ. The central ray B6cₖ may propagate in the first vertical plane, which also includes the axis AX0. The direction of the peripheral ray B6eₖ may be defined by an angle Δβₑₖ with respect to the direction of the central ray B6cₖ. Δβ_{dk} may denote the angle between the direction of the ray B6dₖ and the direction of the central ray B6cₖ. Δβₑₖ may denote the angle between the direction of the ray B6eₖ and the direction of the central ray B6cₖ. The sum Δβ_{dk}+Δβₑₖ may denote the angle between the peripheral rays B6dₖ, B6eₖ. The sum Δβ_{dk}+Δβₑₖ may be equal to the cone angle of the focused beam B6ₖ in the tangential direction of the annular optical image IMG1. The cone angle may also be called as the vertex angle or as the full cone angle. The half cone angle of the focused beam B6ₖ may be equal to Δβ_{dk} in a situation where Δβ_{dk}=Δβₑₖ.

The sum Δφₐₖ+Δφ_{bk} may depend on the dimensions of the aperture stop AS1 and on the focal length of the focusing unit 300. In particular, the sum Δφₐₖ+Δφ_{bk} may depend on the diameter d_{AS1} of the aperture stop AS1. The diameter d_{AS1} of the aperture stop AS1 and the focal length of the focusing unit 300 may be selected such that the sum Δφₐₖ+Δφ_{bk} is e.g. greater than 9°.

The sum Δβ_{dk}+Δβₑₖ may depend on the diameter of the aperture stop AS1 and on the focal length of the focusing unit 300. In particular, the sum Δβ_{dk}+Δβₑₖ may depend on the diameter d_{AS1} of the aperture stop AS1. The diameter d_{AS1} of the aperture stop AS1 and the focal length of the aperture stop AS1 may be selected such that the sum Δβ_{dk}+Δβₑₖ is e.g. greater than 9°.

The dimensions (d_{AS1}) of the aperture stop AS1 may be selected such that the ratio (Δφₐₖ+Δφ_{bk})/(Δβ_{d1}+Δβₑ₁) is in the range of 0.7 to 1.3, in order to provide sufficient image quality. In particular, the ratio (Δφₐₖ+Δφ_{bk})/(Δβ_{d1}+Δβₑ₁) may be in the range of 0.9 to 1.1 to optimize spatial resolution in the radial direction of the image IMG1 and in the tangential direction of the image IMG1. The cone angle (Δφₐₖ+Δφ_{bk}) may have an effect on the spatial resolution in the radial direction (DIRₖ′), and the cone angle (Δβ_{d1}+Δβₑ₁) may have an effect on the spatial resolution in the tangential direction (the tangential direction is perpendicular to the direction DIRₖ′).

The light of an input beam B0ₖ having elevation angle θₖ may be focused to provide a focused beam B6ₖ, which impinges on the image sensor DET1 on the image point Pₖ′. The F-number F(θₖ) of the imaging device 500 for the elevation angle θₖ may be defined by the following equation:

$$F ( {θ}_{k} ) = \frac{1}{2 \cdot {NA}_{IMG , k}} \qquad ( 4 a )$$

Where NA_{IMG,k} denotes the numerical aperture of the focused beam B6ₖ. The numerical aperture NA_{IMG,k} may be calculated by using the angles Δφₐₖ and Δφ_{bk}:

$${NA}_{IMG , k} = {n}_{IMG} \cdot sin ( \frac{Δ {φ}_{ak} ( {θ}_{k} ) + Δ {φ}_{bk} ( {θ}_{k} )}{2} ) \qquad ( 4 b )$$

n_{IMG} denotes the refractive index of light-transmitting medium immediately above the image sensor DET1. The angles Δφₐₖ and Δφ_{bk} may depend on the elevation angle θₖ. The F-number F(θₖ) for the focused beam B6ₖ may depend on the elevation angle θₖ of the corresponding input beam B0ₖ.

A minimum value F_{MIN} may denote the minimum value of the function F(θₖ) when the elevation angle θₖ is varied from the lower limit θ_{MIN} to the upper limit θ_{MAX} The effective F-number of the imaging device 500 may be defined to be equal to said minimum value F_{MIN}.

The light-transmitting medium immediately above the image sensor DET1 may be e.g. gas, and the refractive index may be substantially equal to 1. The light-transmitting medium may also be e.g. a (protective) light-transmitting polymer, and the refractive index may be substantially greater than 1.

The modulation transfer function MTF of the imaging device 500 may be measured or checked e.g. by using an object O1, which has a stripe pattern. The image IMG1 may comprise a sub-image of the stripe pattern such that the sub-image has a certain modulation depth. The modulation transfer function MTF is equal to the ratio of image modulation to the object modulation. The modulation transfer function MTF may be measured e.g. by providing an object O1 which has a test pattern formed of parallel lines, and by measuring the modulation depth of the corresponding image IMG1. The modulation transfer function MTF may be normalized to unity at zero spatial frequency. In other words, the modulation transfer function may be equal to 100% at the spatial frequency 0 line pairs/mm. The spatial frequency may be determined at the image plane PLN1, i.e. on the surface of the image sensor DET1.

The lower limit of the modulation transfer function MTF may be limited by the optical aberrations of the device 500, and the upper limit of the modulation transfer function MTF may be limited by diffraction.

FIG. 9c shows, by way of example, the modulation transfer function MTF of an imaging device 500 for three different elevation angles θₖ=0°, θₖ=20°, and θₖ=35°. The solid curves shows the modulation transfer function when the test lines appearing in the image IMG1 are oriented tangentially with respect to the center point CP1. The dashed curves shows the modulation transfer function when the test lines appearing in the image IMG1 are oriented radially with respect to the center point CP1. FIG. 9c shows modulation transfer function curves of the imaging device 500 specified in Tables 1.1 to 1.3.

Each curve of FIG. 9c represents the average of modulation transfer functions MTF determined at the wavelength 486 nm, 587 nm ja 656 nm.

The outer diameter d_{MAX} of the annular image IMG1 and the modulation transfer function MTF of the device 500 may depend on the focal length f₁ of the device 500. In case of FIG. 9c, the focal length f₁ is equal to 1.26 mm and the outer diameter d_{MAX} of the annular image IMG1 is equal to 3.5 mm.

For example, the modulation transfer function MTF at the spatial frequency 90 line pairs/mm may be substantially equal to 54%. For example, the modulation transfer function MTF at the spatial frequency 90 line pairs/mm may be higher than 50% for the whole vertical field of view from 0° to +35°. The whole width (d_{MAX}) of the annular image IMG1 may comprise approximately 300 line pairs when the spatial frequency is equal to 90 line pairs/mm and the outer diameter d_{MAX} of the annular image IMG1 is equal to 3.5 mm (3.5 mm·90 line pairs/mm=315 line pairs).

The modulation transfer function MTF of the imaging device 500 at a first spatial frequency ν₁ may be higher than 50% for each elevation angle θₖ which is in the vertical field of view from θ_{MAX} to θ_{MIN}, wherein the first spatial frequency ν₁ is equal to 300 line pairs divided by the outer diameter d_{MAX} of the annular optical image IMG1, and the effective F-number F_{eff} of the device 500 may be e.g. in the range of 1.0 to 5.6.

The shapes of the optical surfaces of the input element LNS1 and the diameter d_{AS1} of the aperture stop AS1 may be selected such that the modulation transfer function MTF of the imaging device 500 at a first spatial frequency ν₁ may be higher than 50% for at least one elevation angle θₖ which is in the range of 0° to +35°, wherein the first spatial frequency ν₁ is equal to 300 line pairs divided by the outer diameter d_{MAX} of the annular optical image IMG1, and the effective F-number F_{eff} of the device 500 may be e.g. in the range of 1.0 to 5.6. The modulation transfer function at the first spatial frequency ν₁ and at said at least one elevation angle θₖ may be higher than 50% in the radial direction and in the tangential direction of the optical image IMG1.

The shapes of the optical surfaces of the input element LNS1 and the diameter d_{AS1} of the aperture stop AS1 may be selected such that the modulation transfer function MTF of the imaging device 500 at a first spatial frequency ν₁ may be higher than 50% for each elevation angle θₖ which is in the range of 0° to +35°, wherein the first spatial frequency ν₁ is equal to 300 line pairs divided by the outer diameter d_{MAX} of the annular optical image IMG1, and the effective F-number F_{eff} of the device 500 may be e.g. in the range of 1.0 to 5.6. The modulation transfer function at the first spatial frequency ν₁ and at each of said elevation angles θₖ may be higher than 50% in the radial direction and in the tangential direction of the optical image IMG1.

The width W_{DET1} of active area of the image sensor DET1 may be greater than or equal to the outer diameter d_{MAX} of the annular image IMG1.

The shapes of the optical surfaces of the input element LNS1 and the diameter d_{AS1} of the aperture stop AS1 may be selected such that the modulation transfer function MTF of the imaging device 500 at a first spatial frequency ν₁ may be higher than 50% for each elevation angle θₖ which is in the range of 0° to +35°, wherein the first spatial frequency ν₁ is equal to 300 line pairs divided by the width W_{DET1} of the active area of the image sensor DET1, and the effective F-number F_{eff} of the device 500 may be e.g. in the range of 1.0 to 5.6. The modulation transfer function at the first spatial frequency ν₁ and at each of said elevation angles θₖ may be higher than 50% in the radial direction and in the tangential direction of the optical image IMG1.

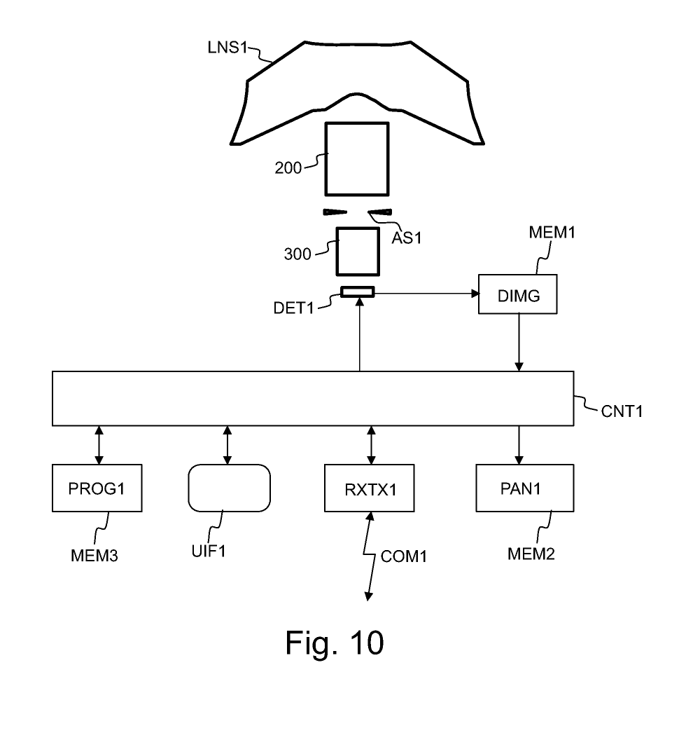

FIG. 10 shows functional units of the imaging device 500. The imaging device 500 may comprise a control unit CNT1, a memory MEM1, a memory MEM2, a memory MEM3. The imaging device 500 may optionally comprise a user interface UIF1 and/or a communication unit RXTX1.

The input element LNS1 and the focusing unit 300 may be arranged to form an optical image IMG1 on the image sensor DET1. The image sensor DET1 may capture the image DIMG1. The image sensor DET1 may convert the optical image IMG1 into a digital image DIMG1, which may be stored in the operational memory MEM1. The image sensor DET1 may provide the digital image DIMG1 from the optical image IMG1.

The control unit CNT1 may be configured to form a panoramic image PAN1 from the digital image DIMG1. The panoramic image PAN1 may be stored e.g. in the memory MEM2.

The control unit CNT1 may comprise one or more data processors. The control unit CNT1 may be configured to control operation of the imaging device 500 and/or the control unit CNT1 may be configured to process image data. The memory MEM3 may comprise computer program PROG1. The computer program code PROG1 may be configured to, when executed on at least one processor CNT1, cause the imaging device 500 to capture the annular image DIMG1 and/or to convert the annular image DIMG1 into a panoramic image PAN1.

The device 500 may be arranged to receive user input from a user via the user interface UIF1. The device 500 may be arranged to display one or more images DIMG, PAN1 to a user via the user interface UIF1. The user interface UIF1 may comprise e.g. a display, a touch screen, a keypad, and/or a joystick.

The device 500 may be arranged to send the images DIMG and/or PAN1 by using the communication unit RXTX1. COM1 denotes a communication signal. The device 500 may be arranged to send the images DIMG and/or PAN1 e.g. to a remote device or to an Internet server. The communication unit RXTX1 may be arranged to communicate e.g. via a mobile communications network, via a wireless local area network (WLAN), and/or via the Internet. The device 500 may be connected to a mobile communication network such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks.

The device 500 may also be implemented in a distributed manner. For example, the digital image DIMG may be transmitted to a (remote) server, and forming the panoramic image PAN1 from the digital image DIMG may be performed by the server.

The imaging device 500 may be arranged to provide a video sequence, which comprises one or more panoramic images PAN1 determined from the digital images DIMG1. The video sequence may be stored and/or communicated by using a data compression codec, e.g. by using MPEG-4 Part 2 codec, H.264/MPEG-4 AVC codec, H.265 codec, Windows Media Video (WMV), DivX Pro codec, or a future codec (e.g. High Efficiency Video Coding, HEVC, H.265). The video sequence may encoded and/or decoded e.g. by using MPEG-4 Part 2 codec, H.264/MPEG-4 AVC codec, H.265 codec, Windows Media Video (WMV), DivX Pro codec, or a future codec (e.g. High Efficiency Video Coding, HEVC, H.265). The video data may also be encoded and/or decoded e.g. by using a lossless codec.

The images PAN1 may be communicated to a remote display or image projector such that the images PAN1 may be display by said remote display (or projector). The video sequence comprising the images PAN1 may be communicated to a remote display or image projector.

The input element LNS1 may be produced e.g. by molding, turning (with a lathe), milling, and/or grinding. In particular, the input element LNS1 may be produced e.g. by injection molding, by using a mold. The mold for making the input element LNS1 may be produced e.g. by turning, milling, grinding and/or 3D printing. The mold may be produced by using a master model. The master model for making the mold may be produced by turning, milling, grinding and/or 3D printing. The turning or milling may comprise using a diamond bit tool. If needed, the surfaces may be polished e.g. by flame polishing and/or by using abrasive techniques.

The input element LNS1 may be a solid body of transparent material. The material may be e.g. plastic, glass, fused silica, or sapphire.

In particular, the input element LNS1 may consist of a single piece of plastic which may be produced by injection molding. Said single piece of plastic may be coated or uncoated. Consequently, large amounts of input element LNS1 may be produced with relatively low manufacturing costs.

The shape of the surface SRF1 may be selected such that the input element LNS1 may be easily removed from a mold.

The thickness of the input element LNS1 may depend on the radial position. The input element LNS1 may have a maximum thickness at a first radial position and a minimum thickness at a second radial position (The second radial position may be e.g. smaller than 90% of the outer radius of the input element LNS1). The ratio of the minimum thickness to the maximum thickness may be e.g. greater than or equal to 0.5 in order to facilitate injection molding.

The optical interfaces of the optical elements may be optionally coated with anti-reflection coating(s).

The reflective surfaces SRF2, SRF3 of the input element LNS1 may be arranged to reflect light by total internal reflection (TIR). The orientations of the reflective surfaces SRF2, SRF3 and the refractive index of the material of the input element LNS1 may be selected to provide the total internal reflection (TIR).

In an embodiment, the imaging device 500 may be arranged to form the optical image IMG1 from infrared light. The input element LNS1 may comprise e.g. silicon or germanium for refracting and transmitting infrared light.

The image sensor DET1 may comprise a two-dimensional array of light-detecting pixels. The two-dimensional array of light-detecting pixels may also be called as a detector array. The image sensor DET1 may be e.g. a CMOS image sensor Complementary Metal Oxide Semiconductor) or a CCD image sensor (Charge Coupled Device). The active area of the image sensor DET1 may be substantially parallel to a plane defined by the directions SX and SY.

The resolution of the image sensor DET1 may be selected e.g. from the following list: 800×600 pixels (SVGA), 1024×600 pixels (WSVGA), 1024×768 pixels (XGA), 1280×720 pixels (WXGA), 1280×800 pixels (WXGA), 1280×960 pixels (SXGA), 1360×768 pixels (HD), 1400×1050 pixels (SXGA+), (1440×900 pixels (WXGA+), 1600×900 pixels (HD+), 1600×1200 pixels (UXGA), 1680×1050 pixels (WSXGA+), 1920×1080 pixels (full HD), 1920×1200 pixels (WUXGA), 2048×1152 pixels (QWXGA), 2560×1440 pixels (WQHD), 2560×1600 pixels (WQXGA), 3840×2160 pixels (UHD-1), 5120×2160 pixels (UHD), 5120×3200 pixels (WHXGA), 4096×2160 pixels (4K), 4096×1716 pixels (DCI 4K), 4096×2160 (DCI 4K), 7680×4320 pixels (UHD-2).

In an embodiment, the image sensor DET1 may also have an aspect ratio 1:1 in order to minimize the number of inactive detector pixels.

In an embodiment, the imaging device 500 does not need to be fully symmetric about the axis AX0. For example, the image sensor DET1 may overlap only half of the optical image IMG1, in order to provide a 180° view. This may provide a more detailed image for the 180° view.

In an embodiment, one or more sectors may be removed from the input element LNS1 to provide a viewing region, which is smaller than 360°.

In an embodiment, the input element LNS1 may comprise one or more holes e.g. for attaching the input element LNS1 to one or more other components. In particular, the input element LNS1 may comprise a central hole. The input element LNS1 may comprise one or more protrusions e.g. for attaching the input element LNS1 to one or more other components.

The direction SY may be called e.g. as the vertical direction, and the directions SX and SY may be called e.g. as horizontal directions. The direction SY may be parallel to the axis AX0. The direction of gravity may be substantially parallel with the axis AX0. However, the direction of gravity may also be arbitrary with respect to the axis AX0. The imaging device 500 may have any orientation with respect to its surroundings.

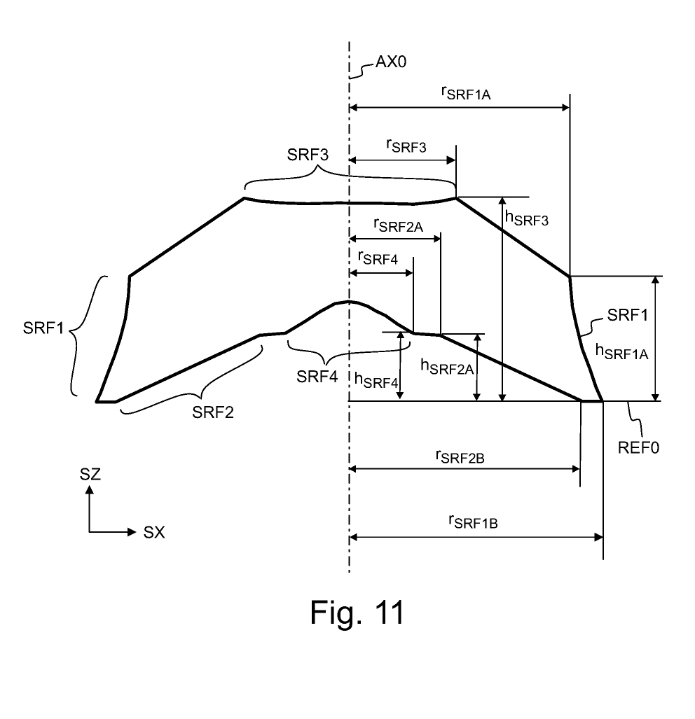

FIG. 11 shows radial dimensions and vertical positions for the input element LNS1. The input surface SRF1 may have a lower boundary having a semi-diameter r_{SRF1B}. The lower boundary may define a reference plane REF0. The input surface SRF1 may have an upper boundary having a semi-diameter r_{SRF1A}. The upper boundary may be at a vertical position h_{SRF1A} with respect to the reference plane REF0. The surface SRF2 may have a lower boundary having a semi-diameter r_{SRF2B}. The surface SRF2 may have an upper boundary having a semi-diameter r_{SRF2A} and a vertical position h_{SRF2A}. The surface SRF3 may have a boundary having a semi-diameter r_{SRF3} and a vertical position h_{SRF3}. The surface SRF4 may have a boundary having a semi-diameter r_{SRF4} and a vertical position h_{SRF4}.

For example, the vertical position h_{SRF4} of the boundary of the refractive output surface SRF4 may be higher than the vertical position h_{SRF2A} of the upper boundary of the reflective surface SRF2. For example, the vertical position h_{SRF3} of the boundary of the reflective output surface SRF3 may be higher than the vertical position h_{SRF1A} of the upper boundary of the input surface SRF1.

Tables 1.1 to 1.3 show parameters, coefficients, and extra data associated with an imaging device of example 1.

TABLE 1.1
General parameters of the imaging device 500 of example 1.

| Effective F-number F_{eff} | 1:2.0 | |
|---|---|---|
| Upper limit θ_{MAX} of elevation angle | +38° | |
| Lower limit θ_{MIN} of elevation angle | −2° | |
| Focal length f₁ | 1.4 | mm |
| Distance between SRF3 and the image sensor DET1 | 26 | mm |
| Outer diameter of the input element LNS1 | 28 | mm |
| Outer radius r_{MAX} of the image IMG1 | 1.75 | mm |
| Inner radius r_{MIN} of the image IMG1 | 0.95 | mm |

TABLE 1.2
Characteristic parameters of the surfaces of example 1.

| | | Radius | Thickness | Refractive | Abbe | Diameter |
|---|---|---|---|---|---|---|
| Surface | Type | (mm) | (mm) | index | Vd | (mm) |
| 1 (SRF1) | Toroidal | −29.2 | 12.3 | 1.531 | 56 | Not applicable |
| 2 | Coordinate break | | 1 | | | |
| 3 (SRF2) | Odd Asphere | Infinite | −5 | 1.531 | 56 | 26 |
| 4 (SRF3) | Even Asphere | 184.9 | 5.4 | 1.531 | 56 | 12 |
| 5 (SRF4) | Even Asphere | 4.08 | 6 | AIR | AIR | 7.2 |
| 6 | Even Asphere | −23 | 2 | 1.531 | 56 | 6.4 |
| 7 | Even Asphere | −9.251 | 5 | AIR | AIR | 6.4 |
| 8 | Aperture stop | | 0.27 | AIR | AIR | 2.6 |
| 9 | Standard | 3.17 | 1.436 | 1.587 | 59.6 | 3.4 |
| 10 | Standard | −3.55 | 0.62 | 1.689 | 31.2 | 3.4 |
| 11 | Standard | 10.12 | 1.47 | AIR | AIR | 3.8 |
| 12 | Even Aspere | −3.3 | 0.9 | 1.531 | 56 | 3.4 |
| 13 | Even Asphere | −2.51 | 0 | AIR | AIR | 4 |
| 14 | Even Asphere | 3.61 | 1.07 | 1.531 | 56 | 4.6 |
| 15 | Even Asphere | 3.08 | 1.4 | AIR | AIR | 4.6 |
| 16 | Plane | Infinite | 0.5 | 1.517 | 64.2 | 6.2 |
| SRF17 | Plane | Infinite | 1.5 | AIR | AIR | 6.2 |
| SRF18 | Image | | | | | 3.5 |

TABLE 1.3
Cofficients and extra data for defining the shapes of the surfaces of example 1.

| | | | | | Radius of | Aperture |
|---|---|---|---|---|---|---|
| Surface | α₁ | α₂ | α₃ | α₄ | rotation | decenter y |
| 1 (SRF1) | −0.034 | 4.467E−04 | −3.61E−06 | 0 | 12.3 | 3.5 |
| | Decenter x | Decenter y | Tilt x | Tilt y | | |
| 2 | 0 | 0 | −90 | 0 | | |
| | α₁ | α₂ | α₃ | α₄ | Aperture rₘᵢₙ | Aperture rₘₐₓ |
| 3 (SRF2) | 0.452 | 0 | 0 | 0 | 5.0 | 13.0 |
| | β₁ | β₂ | β₃ | β₄ | | |
| 4 (SRF3) | −1.194E−03 | −3.232E−04 | 1.195E−06 | 0 | | |
| | α₁ | α₂ | α₃ | α₄ | α₅ | |
| 5 (SRF4) | 0.12 | −0.016 | 6.701E−04 | −2.588E−05 | | |
| 6 | 0.047 | −5.632E−03 | −2.841E−05 | −1.655E−05 | | |
| 7 | −2.536E−03 | −3.215E−03 | −5.943E−05 | −5.695E−07 | | |
| 12 | −3.833E−03 | −5.141E−04 | 1.714E−03 | −4.360E−04 | 1.309E−04 | |
| 13 | −0.088 | 9.328E−03 | 7.336E−03 | −1.670E−03 | 3.009E−04 | |
| 14 | 0.065 | −0.031 | −4.011E−04 | −2.644E−04 | 6.290E−05 | |
| 15 | 0.168 | −0.075 | 3.363E−04 | 6.978E−04 | −6.253E−05 | |

The standard surface may mean a spherical surface centered on the optical axis AX0, with the vertex located at the current axis position. A plane may be treated as a special case of the spherical surface with infinite radius of curvature. The z-coordinate of a standard surface may be given by:

$$z = \frac{{cr}^{2}}{1 + \sqrt{1 - ( 1 + K ) {c}^{2} {r}^{2}}} \qquad ( 4 )$$

r denotes the radius, i.e. the horizontal distance of a point from the axis AX0. The z-coordinate denotes the vertical distance of said point from the vertex of the standard surface. The z-coordinate may also be called as the sag. c denotes the curvature of the surface (i.e. the reciprocal of a radius). K denotes the conic constant. The conic constant K is less than −1 for a hyperboloid. The conic constant K is −1 for a paraboloid surface. The conic constant K is in the range of −1 to 0 for an ellipsoid surface. The conic constant K is 0 for a spherical surface. The conic constant K is greater than 0 for an oblate ellipsoid surface.

A toroidal surface may be formed by defining a curve in the SY-SZ-plane, and then rotating the curve about the axis AX0. The toroidal surface may be defined using a base radius of curvature in the SY-SZ-plane, as well as a conic constant K and polynomial aspheric coefficients. The curve in the SY-SZ-plane may be defined by:

$$z = \frac{{cy}^{2}}{1 + \sqrt{1 - ( 1 + K ) {c}^{2} {y}^{2}}} + {α}_{1} {y}^{2} + {α}_{2} {y}^{4} + {α}_{3} {y}^{6} + {α}_{4} {y}^{8} + {α}_{5} {y}^{10} + … \qquad ( 5 )$$

α₁, α₂, α₃, α₄, α₅, . . . denote polynomial aspheric constants. y denotes horizontal distance of a point from the axis AX0. The z-coordinate denotes the vertical distance of said point from the vertex of the surface. c denotes the curvature, and K denotes the conic constant. The curve of equation (5) is then rotated about the axis AX0 at a distance R from the vertex, in order to define the toroidal surface. The distance R may be called e.g. as the radius of rotation.

An even asphere surface may be defined by:

$$z = \frac{{cr}^{2}}{1 + \sqrt{1 - ( 1 + K ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + … \qquad ( 6 )$$

α₁, α₂, α₃, α₄, α₅, . . . denote polynomial aspheric constants. r denotes the radius, i.e. the horizontal distance of a point from the axis AX0. The z-coordinate denotes the vertical distance of said point from the vertex of the surface. c denotes the curvature, and K denotes the conic constant.

An odd asphere surface may be defined by:

$$z = \frac{{cr}^{2}}{1 + \sqrt{1 - ( 1 + K ) {c}^{2} {r}^{2}}} + {β}_{1} {r}^{1} + {β}_{2} {r}^{2} + {β}_{3} {r}^{3} + {β}_{4} {r}^{4} + {β}_{5} {r}^{5} + … \qquad ( 7 )$$

β₁, β₂, β₃, β₄, β₅, . . . denote polynomial aspheric constants. r denotes the radius, i.e. the horizontal distance of a point from the axis AX0. The z-coordinate denotes the vertical distance of said point from the vertex of the surface. c denotes the curvature, and K denotes the conic constant.

The default value of each polynomial aspheric constant may be zero, unless a non-zero value has been indicated.

In case of an odd asphere, the coefficient (β₁, β₂, β₃, β₄, β₅) of at least one odd power (e.g. r¹, r³, r⁵) deviates from zero. In case of an even asphere, the coefficients (β₁, β₂, β₃, β₄, β₅) of odd powers (e.g. r¹, r³, r⁵) are zero. The values shown in the tables have been indicated according to the coordinate system defined in the operating manual of the Zemax software (ZEMAX Optical Design Program, Users Manual, Oct. 8, 2013). The operating manual is provided by a company Radiant Zemax, LLC, Redmond USA.

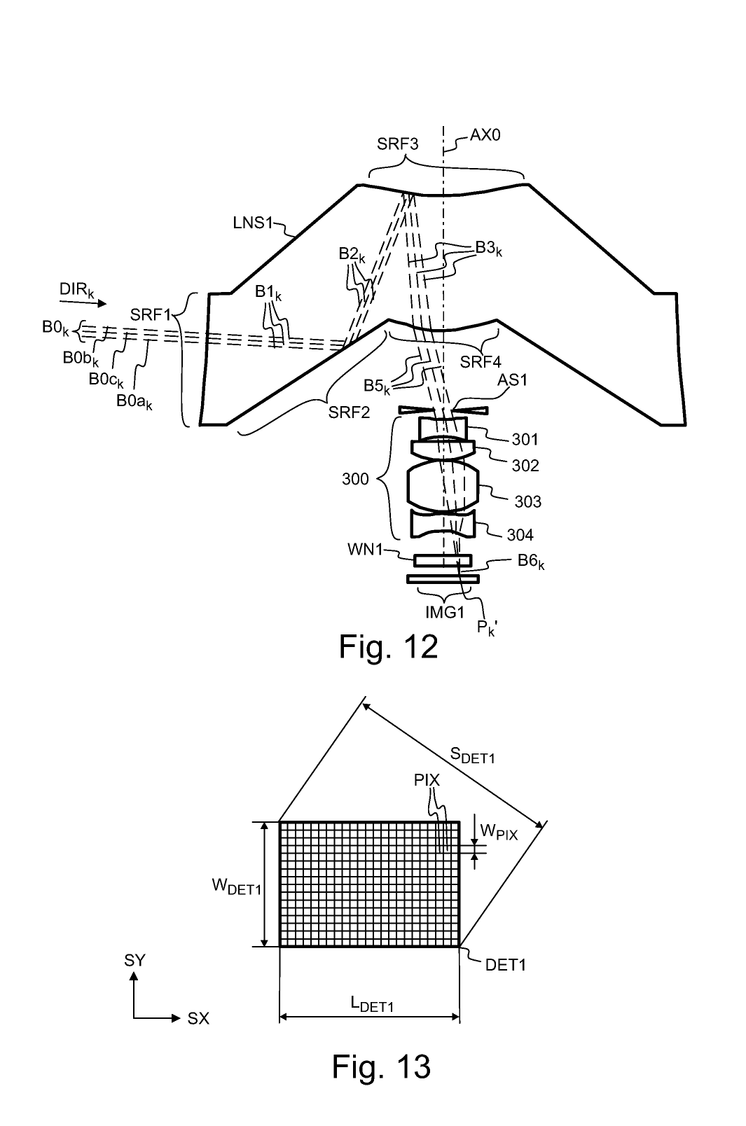

FIG. 12 shows an example where the imaging device 500 does not need to comprise the beam modifying unit 200 between the input element LNS1 and the aperture stop AS1. In this case, the input element LNS1 may directly provide the intermediate beam B5ₖ. Tables 2.1 to 2.3 show parameters associated with an example 2, where the output beam of the input element LNS1 is directly guided via the aperture stop AS1.

TABLE 2.1
General parameters of the imaging device 500 of example 2.

| Effective F-number F_{eff} | 1:3.8 | |
|---|---|---|
| Upper limit θ_{MAX} of elevation angle | +11° | |
| Lower limit θ_{MIN} of elevation angle | −11° | |
| Focal length f₁ | 1.26 | mm |
| Total system height | 20 | mm |
| Outer diameter of input element LNS1 | 24 | mm |
| Image disc outer radius r_{MAX} | 1.6 | mm |
| Image disc inner radius r_{MIN} | 0.55 | mm |

TABLE 2.2
Characteristic parameters of the surfaces of example 2.

| Surface | Type | Radius | Thickness | Index n | Abbe Vd | Diameter |
|---|---|---|---|---|---|---|
| 1 (SRF1) | Toroidal | −41.27 | 12 | 1.531 | 56 | N/A |
| 2 | Coordinate break | | 2 | | | |
| 3 (SRF2) | Odd Asphere | INF | −4.5 | 1.531 | 56 | 21.4 |
| 4 (SRF3) | Even Asphere | −11.19 | 6.85 | 1.531 | 56 | 8 |
| 5 (SRF4) | Even Asphere | −6.33 | 4.04 | AIR | AIR | 5.4 |
| 6 | Aperture stop | | 0.5 | AIR | AIR | 0.92 |
| 7 | Standard | −3.056 | 0.81 | 1.689 | 31.3 | 1.6 |
| 8 | Standard | −2.923 | 1.21 | 1.678 | 54.9 | 2.4 |
| 9 | Standard | −3.551 | 0 | AIR | AIR | 3.2 |
| 10 | Even Aspere | 3.132 | 2.62 | 1.531 | 56 | 3.6 |
| 11 | Even Asphere | −3.103 | 0.11 | AIR | AIR | 3.6 |
| 12 | Even Asphere | 13.4 | 0.87 | 1.531 | 56 | 3.2 |
| 13 | Even Asphere | 5.705 | 1.26 | AIR | AIR | 2.6 |
| 16 | Standard | INF | 0.5 | 1.517 | 64.2 | 3 |
| 17 | Standard | INF | 0.5 | AIR | AIR | 3 |
| 18 | Image | | | | | 3.5 |

TABLE 2.3
Cofficients and extra data for defining the shapes of the surfaces of example 2.

| | | | | | Radius of | Aperture |
|---|---|---|---|---|---|---|
| Surface | α₁ | α₂ | α₃ | α₄ | rotation | decenter y |
| 1 (SRF1) | 6.087E−03 | 2.066E−06 | 0 | 0 | 12 | 6 |
| | Decenter x | Decenter y | Tilt x | Tilt y | | |
| 2 | 0 | 0 | −90 | 0 | | |
| | β₁ | β₂ | β₃ | β₄ | Aperture rₘᵢₙ | Aperture rₘₐₓ |
| 3 (SRF2) | 0.643 | 0 | 0 | 0 | 3.0 | 10.7 |
| | α₁ | α₂ | α₃ | α₄ | α₅ | |
| 4 (SRF3) | 9.698E−04 | −5.275E−06 | 1.786E−08 | 0 | | |
| 5 (SRF4) | −2.118E−04 | 2.360E−04 | 3.933E−06 | 0 | | |
| 10 | 0 | −1.085E−03 | −1.871E−03 | 6.426E−04 | | |
| 11 | 0 | −3.378E−03 | −7.316E−04 | 7.510E−04 | | |
| 12 | 0 | −3.026E−03 | −3.976E−03 | −4.296E−03 | 0.000E+00 | |
| 13 | 0 | 0.095 | −0.018 | −1.125E−03 | 0.000E+00 | |

The notation E-03 means 10⁻³, E-04 means 10⁻⁴, E-05 means 10⁻⁵, E-06 means 10⁻⁶, E-07 means 10⁻⁷, and E-08 means 10⁻⁸.

The device 500 of example 1 (specified in tables 1.1, 1.2, 1.3) and/or the device of example 2 (specified in tables 2.1, 2.2, 3.2) may be used e.g. when the wavelength of the input beam B0ₖ is in the range of 450 nm to 650 nm. The device 500 of example 1 (tables 1.1, 1.2, 1.3) and/or the device of example 2 (tables 2.1, 2.2, 3.2) may provide a high performance simultaneously for the whole wavelength range from 450 nm to 650 nm. The device 500 of example 1 or 2 may be used e.g. for capturing a color image IMG1 by receiving visible input light.

The device 500 of example 1 or 2 may also be scaled up or scaled down e.g. according to the size of the image sensor DET1. The optical elements of the device 500 may be selected so that the size of the optical image IMG1 may match with the size of the image sensor DET1. An imaging device may have dimensions, which may be determined e.g. by multiplying dimensions of example 1 or 2 with a constant value. Said constant value may be called e.g. as a scaling-up factor or as scaling down factor.

Referring to FIG. 13, the image sensor DET1 may comprise a plurality of detector pixels PIX. The detector pixels PIX may be arranged in a two-dimensional rectangular array. An individual pixel PIX may have a width W_{PIX}. The detector pixels of the sensor DET1 may have a width W_{PIX}. The pixel width W_{PIX} may be e.g. in the range of 1 μm to 10 μm. The highest spatial frequency ν_{CUT1} which can be detected by image sensor DET1 may be called as the spatial cut-off frequency ν_{CUT1} of the image sensor DET1. The highest spatial frequency ν_{CUT1} which can be detected by image sensor DET1 may be equal to 0.5/W_{PIX} (=0.5 line pairs/W_{PIX}). For example, the cut-off frequency ν_{CUT1} may be 71 line pairs/mm when the pixel width W_{PIX} is equal to 7 μm.

In an embodiment, the shapes of the optical surfaces of the input element LNS1 and the diameter d_{AS1} of the aperture stop AS1 may be selected such that the modulation transfer function MTF of the imaging device 500 at the spatial cut-off frequency ν_{CUT1} may be higher than 50% for each elevation angle θₖ which is in the range of 0° to +35°, wherein the cut-off frequency γₐₘ is equal to 0.5/W_{PIX}, and the effective F-number F_{eff} of the device 500 may be e.g. in the range of 1.0 to 5.6. The modulation transfer function at the first spatial frequency ν₁ and at each of said elevation angles θₖ may be higher than 50% in the radial direction and in the tangential direction of the optical image IMG1.

In an embodiment, the performance of the imaging optics 500 may also be evaluated based on the size of the image sensor DET1. The image sensor DET1 may have a diagonal dimension S_{DET1}. A reference spatial frequency ν_{REF} may be determined according to the following equation:

$${v}_{REF} = \frac{43.2 mm}{{S}_{DET 1}} \cdot \frac{10 line pairs}{mm} \qquad ( 8 )$$

The shapes of the optical surfaces of the input element LNS1 and the diameter d_{AS1} of the aperture stop AS1 may be selected such that the modulation transfer function MTF of the imaging device 500 at the reference spatial frequency ν_{REF} may be higher than 40% for each elevation angle θₖ which is in the range of 0° to +35°, wherein the reference spatial frequency ν_{REF} is determined according to the equation (8), and the effective F-number F_{eff} of the device 500 is e.g. in the range of 1.0 to 5.6. The modulation transfer function at the reference spatial frequency ν_{REF} and at each of said elevation angles θₖ may be higher than 40% in the radial direction and in the tangential direction of the optical image IMG1.

For example, the diagonal dimension S_{DET1} of the sensor may be substantially equal to 5.8 mm. The reference spatial frequency ν_{REF} calculated from the diagonal dimension 5.8 mm by using the equation (8) may be substantially equal to 74 line pairs/mm. The curves of FIG. 9c show that the modulation transfer function MTF of the imaging device 500 of example 1 satisfies the condition that the modulation transfer function MTF is greater than 50% at the reference spatial frequency ν_{REF}=74 line pairs/mm, for the elevation angles θₖ=0°, θₖ=20°, and θₖ=35°, in the radial direction, and in the tangential direction of the optical image.

Alternatively, the reference spatial frequency ν_{REF} may also be determined according to the following equation:

$${v}_{REF} = \frac{100 line pairs / mm}{\sqrt{\frac{{d}_{MA X}}{mm}}} \qquad ( 9 )$$

where d_{MAX} denotes the outer diameter of the image IMG1. Typically, the spatial resolution of the optical image IMG1 does not need to be higher than the size of the detector pixels. The reference spatial frequency ν_{REF} may be determined according to the equation (9) so that the requirements for the spatial resolution of very small images may be more relaxed than in the case of larger images. For example, the reference spatial frequency ν_{REF} calculated for the outer diameter d_{MAX}=2 mm by using the equation (9) may be substantially equal to 71 line pairs/mm. The reference spatial frequency ν_{REF} corresponding to an outer diameter d_{MAX}=3.5 mm may be substantially equal to 53 line pairs/mm. The reference spatial frequency ν_{REF} corresponding to an outer diameter d_{MAX}=10 mm may be substantially equal to 32 line pairs/mm.

The modulation transfer function MTF of the imaging device 500 at the reference spatial frequency ν_{REF} may be higher than 40% for each elevation angle θₖ which is in the range of 0° to +35°, and the reference spatial frequency ν_{REF} may be equal to 100 line pairs/mm divided by the square root of the dimensionless outer diameter d_{MAX}/mm of the annular optical image IMG1. The dimensionless outer diameter d_{MAX}/mm is calculated by dividing the outer diameter d_{MAX} of the annular optical image IMG1 by a millimeter.

The shapes of the optical surfaces of the input element LNS1 and the diameter d_{AS1} of the aperture stop AS1 may be selected such that the modulation transfer function MTF of the imaging device 500 at the reference spatial frequency ν_{REF} may be higher than 40% for each elevation angle θₖ which is in the range of 0° to +35°, wherein the reference spatial frequency ν_{REF} is determined according to the equation (9), and the effective F-number F_{eff} of the device 500 is e.g. in the range of 1.0 to 5.6. The modulation transfer function at the reference spatial frequency ν_{REF} and at each of said elevation angles θₖ may be higher than 40% in the radial direction and in the tangential direction of the optical image IMG1.

The symbol mm means millimeter, i.e. 10⁻³ meters.

Some variations are illustrated by the following examples:

### Example 1A

An imaging device (500) comprising:
an input element (LNS1),
an aperture stop (AS1), and
a focusing unit (300),

wherein the input element (LNS1) and the focusing unit (300) are arranged to form an annular optical image (IMG1) on an image plane (PLN1), and the aperture stop (AS1) defines an entrance pupil (EPUₖ) of the imaging device (500) such that the effective F-number (F_{eff}) of the imaging device (500) is in the range of 1.0 to 5.6.

### Example 2A

The device (500) of example 1A wherein the ratio (f₁/Wₖ) of the focal length (f₁) of the focusing unit (300) to the width (Wₖ) of the entrance pupil (EPUₖ) is in the range of 1.0 to 5.6, and the ratio (f₁/Δhₖ) of the focal length (f₁) to the height (Δhₖ) of said entrance pupil (EPUₖ) is in the range of 1.0 to 5.6.

### Example 3A

The device (500) of example 1A or 2A wherein the focusing unit (300) is arranged to form a focused beam (B6ₖ) impinging on an image point (Pₖ′) of the annular optical image (IMG1), the position of the image point (Pₖ′) corresponds to an elevation angle (θₖ) of an input beam (B0ₖ), and the dimensions (d_{AS1}) of the aperture stop (AS1) and the focal length (f₁) of the focusing unit (300) have been selected such that the cone angle (Δφₐₖ+Δφ_{bk}) of the focused beam (B6ₖ) is greater than 9° for at least one elevation angle (θₖ) which is in the range of 0° to +35°.

### Example 4A

The device (500) according to any of the examples 1A to 3A wherein the focusing unit (300) is arranged to form a focused beam (B6ₖ) impinging on an image point (Pₖ′) of the annular optical image (IMG1), the position of the image point (Pₖ′) corresponds to an elevation angle (θₖ) of an input beam (B0ₖ), and the dimensions (d_{AS1}) of the aperture stop (AS1) and the focal length (f₁) of the focusing unit (300) have been selected such that the cone angle (Δφₐₖ+Δφ_{bk}) of the focused beam (B6ₖ) is greater than 9° for each elevation angle (θₖ) which is in the range of 0° to +35°.

### Example 5A

The device (500) according to any of the examples 1A to 4A wherein the focusing unit (300) is arranged to form a focused beam (B6ₖ) impinging on an image point (Pₖ′) of the annular optical image (IMG1), the position of the image point (Pₖ′) corresponds to an elevation angle (θₖ) of an input beam (B0ₖ), the modulation transfer function (MTF) of the imaging device (500) at a reference spatial frequency (ν_{REF}) is higher than 40% for each elevation angle (θₖ) which is in the range of 0° to +35°, and the reference spatial frequency (ν_{REF}) is equal to 100 line pairs/mm divided by the square root of a dimensionless outer diameter (d_{MAX}/mm), said dimensionless outer diameter (d_{MAX}/mm) being calculated by dividing the outer diameter (d_{MAX}) of the annular optical image (IMG1) by one millimeter (10⁻³ meters).

### Example 6A

The device (500) according to any of the examples 1A to 4A wherein the focusing unit (300) is arranged to form a focused beam (B6ₖ) impinging on an image point (Pₖ′) of the annular optical image (IMG1), the position of the image point (Pₖ′) corresponds to an elevation angle (θₖ) of an input beam (B0ₖ), the modulation transfer function (MTF) of the imaging device (500) at a first spatial frequency (ν₁) is higher than 50% for each elevation angle (θₖ) which is in the range of 0° to +35°, and the first spatial frequency (ν₁) is equal to 300 line pairs divided by the outer diameter (d_{MAX}) of the annular optical image (IMG1).

### Example 7A

The device (500) according to any of the examples 1A to 6A wherein the input element (LNS1) comprises:
an input surface (SRF1),
a first reflective surface (SRF2),
a second reflective surface (SRF3), and
an output surface (SRF4),

wherein the input surface (SRF1) is arranged to provide a first refracted beam (B1ₖ) by refracting light of an input beam (B0ₖ), the first reflective surface (SRF2) is arranged to provide a first reflected beam (B2ₖ) by reflecting light of the first refracted beam (B1ₖ), the second reflective surface (SRF3) is arranged to provide a second reflected beam (B3ₖ) by reflecting light of the first reflected beam (B2ₖ), and the output surface (SRF4) is arranged to provide an output beam (B4ₖ) by refracting light of the second reflected beam (B3).

### Example 8A

The device (500) of example 7A wherein the second reflected beam (B3ₖ) formed by the second reflective surface (SRF3) does not intersect the first refracted beam (B1ₖ) formed by the input surface (SRF1).

### Example 9A

The device (500) of example 7A or 8A wherein the first refracted beam (B1ₖ), the first reflected beam (B2ₖ), and the second reflected beam (B3ₖ) propagate in a substantially homogeneous material without propagating in a gas.

### Example 10A

The device (500) according to any of the examples 1A to 9A wherein the optical image (IMG1) has an inner radius (r_{MIN}) and an outer radius (r_{MAX}), and the ratio of the inner radius (r_{MIN}) to the outer radius (r_{MAX}) is in the range of 0.3 to 0.7.

### Example 11A

The device (500) according to any of the examples 1A to 10A wherein the vertical field of view (θ_{MAX}-θ_{MIN}) of the imaging device (500) is defined by a first angle value (θ_{MIN}) and by a second angle value (θ_{MAX}), wherein the first angle value (θ_{MIN}) is lower than or equal to 0°, and the second angle value (θ_{MAX}) is higher than or equal to +35°.

### Example 12A

The device (500) of example 11A wherein the first angle value (θ_{MIN}) is lower than or equal to −30°, and the second angle value (θ_{MAX}) is higher than or equal to +45°.

### Example 13A

The device (500) according to any of the examples 1A to 12A wherein the first reflective surface (SRF2) of the input element (LNS1) is a substantially conical surface.

### Example 14A

The device (500) according to any of the examples 1A to 13A, wherein first reflective surface (SRF2) and the second reflective surface (SRF3) of the input element (LNS1) are arranged to reflect light by total internal reflection (TIR).

### Example 15A

The device (500) according to any of the examples 1A to 14A wherein the vertical position (h_{SRF3}) of the boundary of the second reflective output surface (SRF3) of the input element (LNS1) is higher than the vertical position (h_{SRF1A}) of the upper boundary of the input surface (SRF1) of the input element (LNS1).

### Example 16A

The device (500) according to any of the examples 1A to 15A wherein input element (LNS1) comprises a central hole for attaching the input element LNS1 to one or more other components.

### Example 17A

The device (500) according to any of the examples 1A to 16A wherein the device (500) is arranged to form an image point (Pₖ′) of the annular optical image (IMG1) by focusing light of an input beam (B0ₖ), and the shapes of the surfaces (SRF1, SRF2, SRF3, SRF4) of the input element (LNS1) have been selected such that the radial position (rₖ) of the image point (Pₖ′) depends in a substantially linear manner on the elevation angle (θₖ) of the input beam (B0ₖ).

### Example 18A

The device (500) according to any of the examples 1A to 17A, wherein the radial distortion of the annular optical image (IMG1) is smaller than 20% when the vertical field of view (θ_{MAX}-θ_{MIN}) is defined by the angles θ_{MIN}=0° and θ_{MAX}=+35°.

### Example 19A

The device (500) according to any of the examples 1A to 18A comprising a wavefront modifying unit (200), wherein the input element LNS1 and the wavefront modifying unit (200) are arranged to provide an intermediate beam (B5ₖ) such that the intermediate beam (B5ₖ) is substantially collimated after passing through the aperture stop (AS1), and the focusing unit (300) is arranged to focus light of the intermediate beam (B5ₖ) to said image plane (PLN1).

### Example 20A

The device (500) according to any of the examples 1A to 19A wherein the device (500) is arranged to form a first image point from first light received via a first entrance pupil, and to form a second image point from second light received via a second different entrance pupil, the imaging device (500) is arranged to form a first intermediate beam from the first light and to form a second intermediate beam from the second light such that the first intermediate beam and the second intermediate beam pass through the aperture stop (AS1), and the aperture stop (AS1) is arranged to define the entrance pupils by preventing propagation of marginal rays (B5oₖ) such that the light of the marginal rays (B0oₖ) do not contribute to forming the annular optical image (IMG1).

### Example 21A

The device (500) according to any of the examples 1A to 20A wherein the focusing unit (300) is arranged to provide a focused beam (B6ₖ), and the diameter (d_{AS1}) of the aperture stop (AS1) has been selected such that the ratio of a first sum (Δφₐₖ+Δφ_{bk}) to a second sum (Δβ_{d1}+Δβₑ₁) is in the range of 0.7 to 1.3, wherein the first sum (Δφₐₖ+Δφ_{bk}) is equal to the cone angle of the focused beam (B6ₖ) in the tangential direction of the annular optical image (IMG1), and the second sum (Δβ_{d1}+Δβₑ₁) is equal to the cone angle of the focused beam (B6ₖ) in the radial direction of the annular optical image IMG1.

### Example 22A

A method for capturing an image by using the device (500) according to any of the examples 1A to 21A, the method comprising forming an annular image (IMG1) on an image plane (PLN1).

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

1. An imaging device comprising:
an input element,
an aperture stop, and
a focusing unit,
wherein the input element and the focusing unit are arranged to form an annular optical image on an image plane, and the aperture stop defines an entrance pupil of the imaging device such that the effective F-number of the imaging device is in the range of 1.0 to 5.6.

2. The device of claim 1 wherein the ratio of the focal length of the focusing unit to the width of the entrance pupil is in the range of 1.0 to 5.6, and the ratio of the focal length to the height of said entrance pupil is in the range of 1.0 to 5.6.

3. The device of claim 1 wherein the focusing unit is arranged to form a focused beam impinging on an image point of the annular optical image, the position of the image point corresponds to an elevation angle of an input beam, and the dimensions of the aperture stop and the focal length of the focusing unit have been selected such that the cone angle of the focused beam (B6ₖ) is greater than 9° for at least one elevation angle which is in the range of 0° to +35°.

4. The device of claim 1 wherein the focusing unit is arranged to form a focused beam impinging on an image point of the annular optical image, the position of the image point corresponds to an elevation angle of an input beam, and the dimensions of the aperture stop and the focal length of the focusing unit have been selected such that the cone angle of the focused beam is greater than 9° for each elevation angle which is in the range of 0° to +35°.

5. The device (500) of claim 1 wherein the focusing unit is arranged to form a focused beam impinging on an image point of the annular optical image, the position of the image point corresponds to an elevation angle of an input beam, the modulation transfer function of the imaging device at a reference spatial frequency is higher than 40% for each elevation angle which is in the range of 0° to +35°, and the reference spatial frequency is equal to 100 line pairs/mm divided by the square root of a dimensionless outer diameter, said dimensionless outer diameter being calculated by dividing the outer diameter of the annular optical image by one millimeter.

6. The device (500) of claim 1 wherein the focusing unit is arranged to form a focused beam impinging on an image point of the annular optical image, the position of the image point corresponds to an elevation angle of an input beam, the modulation transfer function of the imaging device at a first spatial frequency is higher than 50% for each elevation angle which is in the range of 0° to +35°, and the first spatial frequency is equal to 300 line pairs divided by the outer diameter of the annular optical image.

7. The device (500) of claim 1 wherein the input element comprises:
an input surface,
a first reflective surface,
a second reflective surface, and
an output surface,
wherein the input surface is arranged to provide a first refracted beam by refracting light of an input beam, the first reflective surface is arranged to provide a first reflected beam by reflecting light of the first refracted beam, the second reflective surface is arranged to provide a second reflected beam by reflecting light of the first reflected beam, and the output surface is arranged to provide an output beam by refracting light of the second reflected beam.

8. The device of claim 7 wherein the second reflected beam formed by the second reflective surface does not intersect the first refracted beam formed by the input surface.

9. The device (500) of claim 8 wherein the first refracted beam, the first reflected beam, and the second reflected beam propagate in a substantially homogeneous material without propagating in a gas.

10. The device of claim 1 wherein the optical image has an inner radius and an outer radius, and the ratio of the inner radius to the outer radius is in the range of 0.3 to 0.7.

11. The device of claim 1 wherein the vertical field of view of the imaging device (500) is defined by a first angle value and by a second angle value, wherein the first angle value is lower than or equal to 0°, and the second angle value is higher than or equal to +35°.

12. The device of claim 11 is lower than or equal to −30°, and the second angle value is higher than or equal to +45°.

13. The device of claim 1 wherein the first reflective surface of the input element is a substantially conical surface.

14. The device of claim 1, wherein the first reflective surface and the second reflective surface of the input element are arranged to reflect light by total internal reflection.

15. The device of claim 1 wherein the vertical position of the boundary of the second reflective output surface of the input element is higher than the vertical position of the upper boundary of the input surface of the input element.

16. The device of claim 9 wherein the input element comprises a central hole for attaching the input element to one or more other components.

17. The device of claim 1, wherein the radial distortion of the annular optical image is smaller than 20% when the vertical field of view is defined by the angles θ_{MIN}=0° and θ_{MAX}=+35 °.

18. The device of claim 2 comprising a wavefront modifying unit, wherein the input element and the wavefront modifying unit are arranged to provide an intermediate beam such that the intermediate beam is substantially collimated after passing through the aperture stop, and the focusing unit is arranged to focus light of the intermediate beam to said image plane.

19. The device of claim 1 wherein the focusing unit is arranged to provide a focused beam, and the diameter of the aperture stop has been selected such that the ratio of a first sum to a second sum is in the range of 0.7 to 1.3, wherein the first sum is equal to the cone angle of the focused beam in the tangential direction of the annular optical image, and the second sum is equal to the cone angle of the focused beam in the radial direction of the annular optical image.

20. A method for capturing an image by using an imaging device, the imaging device comprising an input element, an aperture stop, and a focusing unit, the method comprising forming an annular optical image on an image plane, wherein the aperture stop defines an entrance pupil of the imaging device such that the effective F-number of the imaging device is in the range of 1.0 to 5.6.
